(19) United States
(12) Patent Application Publication
(10) Pub. No.: US 2020/0034789 A1
(43) Pub. Date: Jan. 30, 2020

(54) Reducing Demurrage Costs

(71) Applicant: SCHLUMBERGER TECHNOLOGY CORPORATION, Sugar Land, TX (US)

(72) Inventors: Bilal Mustafa Zuberi, Spring, TX (US); Donald Leach, Sugar Land, TX (US)

(21) Appl. No.: 16/523,046

(22) Filed: Jul. 26, 2019

Related U.S. Application Data
(60) Provisional application No. 62/711,302, filed on Jul. 27, 2018.

(51) Int. Cl. G06Q 10/08; G06Q 40/00; H04W 4/029

(52) U.S. Cl. CPC G06Q 10/0835; H04W 4/029; G06Q 40/125; G06Q 10/0833

(57) ABSTRACT

Systems and methods for monitoring, controlling, and/or reducing demurrage costs are disclosed. A method may comprise causing a computing device to receive and record shipping information for a plurality of shipments to and/or from a plurality of oil and gas wellsites using a plurality of ground transportation units, each shipment having an itinerary of one or more loading actions in one or more corresponding predetermined geographic loading zones and one or more unloading actions in one or more corresponding predetermined geographic unloading zones. The method may further comprise, for each shipment, calculating a loading time spent within each of the predetermined geographic loading zones and an unloading time spent within each of the predetermined geographic unloading zones, and suggesting changes to one or more future portions of a corresponding itinerary for one or more of the plurality of shipments to reduce loading time, unloading time, and/or demurrage costs.

### CROSS-REFERENCE TO RELATED APPLICATIONS

This application claims priority to and the benefit of U.S. Provisional Application No. 62/711,302, titled “REDUCING DEMURRAGE COSTS,” filed Jul. 27, 2018, the entire disclosure of which is hereby incorporated herein by reference.

### BACKGROUND OF THE DISCLOSURE

In the shipping industry, demurrage is a financial penalty assessed by shipping (e.g., trucking) companies to hiring companies for exceeding time permitted (e.g., contracted) for loading or unloading cargo transported by the shipping companies. In the oil and gas industry, demurrage charges may be incurred at origin or loading locations (e.g., bulk storage facilities, transload facilities) and/or at destination or unloading locations (e.g., wellsites), while truck trailer units wait for cargo to be loaded or unloaded. Shipping personnel (e.g., truck drivers) manually report and/or record time spent at the origin and destination locations, whether after the truck trailer units are loaded and unloaded, after a delivery job is complete, or at the end of a workday. Relying on shipping personnel to manually report and/or record arrival, departure, and/or shipping delay times can result in the shipping companies assessing demurrage charges that are highly inaccurate.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a computer program product including a non-transitory, computer-readable medium having instructions that, when executed by a processor of a computing device, cause the computing device to receive and record shipping information for shipments to be made and being made to and/or from a plurality of oil and gas wellsites using ground transportation units. Each shipment has an itinerary of one or more loading actions in one or more corresponding predetermined geographic loading zones and one or more unloading actions in one or more corresponding predetermined geographic unloading zones. The shipping information for each shipment includes data indicating geographic location and time of each ground transportation unit while each shipment is being performed, data indicating times at which each ground transportation unit entered and exited each of the predetermined geographic loading zones during each shipment, data indicating times at which each ground transportation unit entered and exited each of the predetermined geographic unloading zones during each shipment, and an algorithm for calculating demurrage costs for each shipment. The algorithm includes a loading demurrage time and an unloading demurrage time at or below each of which no demurrage costs are invoiced. The instructions also cause the computing device to, for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones. The instructions also cause the computing device to, based on an analysis of the shipping information in real time, suggest changes to one or more future portions of a corresponding itinerary for one or more of the shipments to reduce loading time, unloading time, demurrage costs, or a combination thereof.

The present disclosure also introduces a system including a computing device, having a processor, and a non-transitory, computer-readable medium including instructions. The instructions, when executed by the processor of the computing device, cause the computing device to receive and record shipping information for shipments to be made and being made to and/or from oil and gas wellsites using ground transportation units. Each shipment has an itinerary of one or more loading actions in one or more corresponding predetermined geographic loading zones and one or more unloading actions in one or more corresponding predetermined geographic unloading zones. The shipping information for each shipment includes data indicating geographic location and time of each ground transportation unit while each shipment is being performed, data indicating times at which each ground transportation unit entered and exited each of the predetermined geographic loading zones during each shipment, data indicating times at which each ground transportation unit entered and exited each of the predetermined geographic unloading zones during each shipment, and an algorithm for calculating demurrage costs for each shipment. The algorithm includes a loading demurrage time and an unloading demurrage time, at or below each of which no demurrage costs are invoiced. The instructions, when executed by the processor of the computing device, also cause the computing device to, for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones. The instructions, when executed by the processor of the computing device, also cause the computing device to, based on an analysis of the shipping information in real time, suggest changes to one or more future portions of a corresponding itinerary for one or more of the shipments to reduce loading time, unloading time, demurrage costs, or a combination thereof.

The present disclosure also introduces a method for monitoring and/or controlling demurrage costs. The method includes causing a computing device to receive and record shipping information for shipments to be made and being made to and/or from oil and gas wellsites using ground transportation units. Each shipment has an itinerary of one or more loading actions in one or more corresponding predetermined geographic loading zones and one or more unloading actions in one or more corresponding predetermined geographic unloading zones. The shipping information for each shipment includes data indicating geographic location and time of each ground transportation unit as each shipment is being performed, data indicating times at which each ground transportation unit entered and exited each of the predetermined geographic loading zones during each shipment, data indicating times at which each ground transportation unit entered and exited each of the predetermined geographic unloading zones during each shipment, and an algorithm for calculating demurrage costs for each shipment. The algorithm includes a loading demurrage time and an unloading demurrage time, at or below each of which no demurrage costs are invoiced. The method also includes causing the computing device to, for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones. The method also includes causing the computing device to, based on an analysis of the shipping information in real time, suggest changes to one or more future portions of a corresponding itinerary for one or more of the shipments to reduce loading time, unloading time, demurrage costs, or a combination thereof. The computing device includes a processor with a non-transitory, computer-readable medium that includes instructions that are executed by the processor of the computing device, resulting in at least a portion of the method being undertaken.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a schematic view of at least a portion of an example implementation of apparatus according to one or more aspects of the present disclosure.

FIG. 4 is a schematic view of at least a portion of an example implementation of apparatus according to one or more aspects of the present disclosure.

FIG. 5 is a schematic view of at least a portion of an example implementation of apparatus according to one or more aspects of the present disclosure.

FIG. 6 is a schematic view of at least a portion of an example implementation of apparatus according to one or more aspects of the present disclosure.

FIG. 7 is a flow-chart diagram of at least a portion of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed.

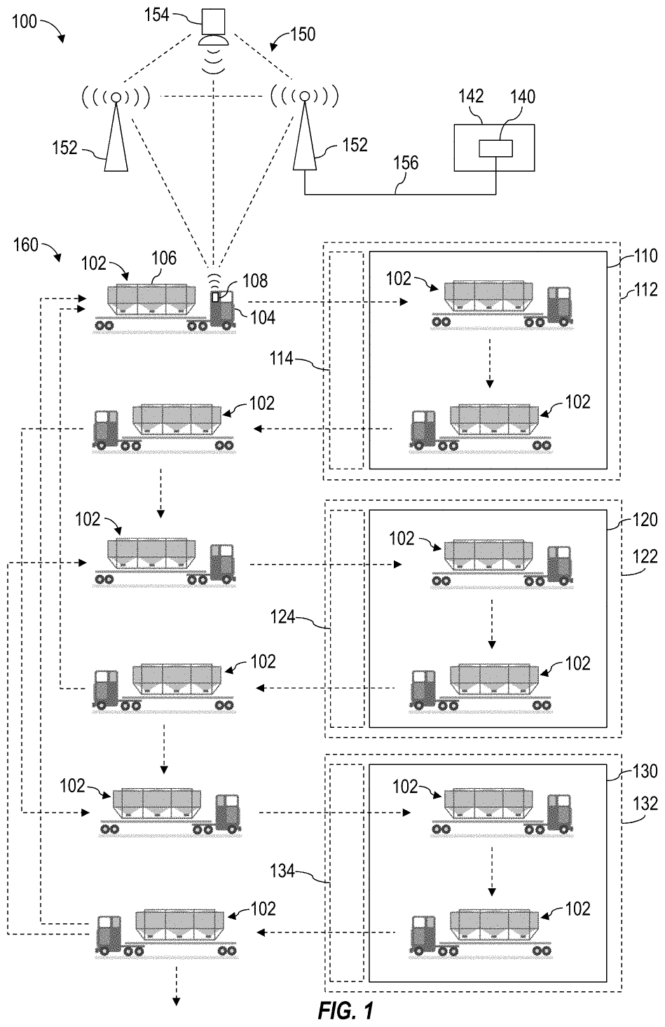

FIG. 1 is a schematic view of at least a portion of an example implementation of a communication system 100 for tracking and guiding a plurality of shipments moving via ground transportation units 102 between one or more origin locations 110 (e.g., loading or distribution facilities or areas) and one or more destination locations 120, 130 (e.g., unloading facilities or areas) according to one or more aspects of the present disclosure. As used herein, a “plurality” should be understood to include two or more, for example three or more. The communication system 100 may be operable to track and guide the ground transportation units 102 while the ground transportation units 102 move to and from such locations 110, 120, 130. The communication system 100 may be utilized, for example, in the oil and gas industry to track and guide the ground transportation units 102 between material storage locations and wellsites utilizing the material to perform wellsite operations, such as well drilling, cementing, acidizing, water jet cutting, and/or hydraulic fracturing, among other examples. However, it is to be understood that the communication system 100 may be utilized in other industries, such as the mining industry for tracking and guiding movement of material between storage locations and mining sites, and/or the construction industry for tracking and guiding movement of material between storage locations and construction sites.

The communication system 100 may comprise a computing device 140 (e.g., a server) housed at a predetermined location 142 (e.g., a communication center) remote from the origin locations 110 and the destination locations 120, 130, each of which may be located at substantial distances from each other. The communication system 100 may further comprise a plurality of mobile computing devices 108 each carried by or otherwise disposed in association with a corresponding ground transportation units 102. For example, each mobile computing device 108 may be installed within a corresponding ground transportation unit 102 or each mobile computing device 108 may be carried by an operator of the corresponding ground transportation unit 102 (e.g., a truck driver). To differentiate the mobile computing devices 108 from the computing device 140, the computing device 140 may hereinafter be referred to as a first or stationary computing device 140, even though such stationary computing device 140 may be disposed within or carried by a mobile trailer or another vehicle.

The stationary computing device 140 may be wirelessly communicatively connected with the mobile computing devices 108 via a wireless communication network 150 (e.g., a cellular communication network, a satellite communication network, etc.). The wireless communication network 150 may comprise a plurality of wireless access points 152 (e.g., cellular communication towers) and a communication satellite 154 communicatively connected with each other. Each mobile computing device 108 may be or comprise a wireless transmitter and/or receiver (e.g., a transceiver) operable to wirelessly connect with one or more of the communication satellite 154 and the wireless access points 152 located within a communication range of the mobile computing device 108. Communication between the wireless communication network 150 and the stationary computing device 140 may be facilitated via a wired connection 156 and/or a wireless connection (not shown). The wireless communication network 150 may facilitate communication between the stationary computing device 140 and the mobile computing devices 108 and real-time tracking of the mobile computing devices 108 and, thus, the ground transportation units 102 carrying the mobile computing devices 108.

FIG. 1 further shows example shipping (i.e., travel) routes 160 that may be taken by a ground transportation unit 102 during a shipping (i.e., delivery) trip (or shipment), as indicated by various arrows 160. Each ground transportation unit 102 may comprise a truck 104 and a trailer 106 configured to transport cargo material therein. The origin location 110, the destination locations 120, 130, and/or shipping routes (e.g., shipping routes 160) for a shipment of cargo material to be transported by a ground transportation unit 102 may be contained within or indicated by a shipping itinerary (i.e., plan), which may be provided to the driver of each ground transportation unit 102 to guide the shipment from the origin location 110 to the destination locations 120, 130. An itinerary may be transmitted to each driver via a corresponding mobile computing device 108.

Movements of the mobile computing devices 108 and, thus, the shipping routes 160 for each ground transportation unit 102, may be tracked and/or recorded by the mobile computing devices 108. The shipping (e.g., tracking, location arrival, location departure, etc.) information may be transmitted in real-time to the stationary computing device 140 for processing and analysis, as described in additional detail below. The stationary computing device 140 may then determine in real-time alternate shipping routes for the ground transportation units 102 based on, for example, location of the ground transportation units 102, the distances between ground transportation units 102 and origin and destination locations 110, 120, 130, and/or transportation delays experienced by the ground transportation units 102 at the origin and destination locations 110, 120, 130. An alternate itinerary (or a changed future or not yet completed portion of an itinerary) containing alternate shipping routes may then be transmitted to one or more of the drivers to suggest or mandate an alternate origin location 110, destination locations 120, 130, and/or shipping routes 160 to guide the corresponding shipments to reduce loading time, unloading time, demurrage costs, or a combination thereof.

An example itinerary may indicate that the ground transportation unit 102 is to travel to the origin location 110 to receive the cargo material and then travel to the destination location 120 to unload at least a portion of the cargo material. The itinerary may further indicate that the ground transportation unit 102 is to then depart the destination location 120 and travel to the destination location 130 to unload at least a portion of the cargo material. The itinerary may then specify that the ground transportation unit 102 depart the destination location 130 and return to the origin location 110 to pick up additional cargo material. However, while completing the shipment specified in the shipping itinerary, a driver of the ground transportation unit 102 may receive a revised itinerary that, for example, specifies one or more different origin locations, 110, destination locations 120, 130, shipping routes 160, and/or changes in order of delivery to one or more destination locations 120, 130. Such changes to the itinerary may be automatically generated by the stationary computing device 140 and provided to the driver in real-time via the mobile computing device 108. For example, after the ground transportation unit 102 exits the origin location 110, the revised itinerary may specify that the ground transportation unit 102 travel directly to the destination location 130 to unload at least a portion of the cargo material and then to the destination location 120 to unload at least a portion of the cargo material. The revised itinerary may also or instead specify that the ground transportation unit 102 travel from the destination location 130 to another destination location (not shown) or return to the origin location 110 to pick up additional cargo material.

Such changes to the itinerary may be initiated or otherwise caused by, for example, delays in entering the origin or destination locations 110, 120, 130, such as when a large number of ground transportation units 102 are attempting to enter the locations 110, 120, 130. Changes to the itinerary may also or instead be initiated or otherwise caused by, for example, delays in loading or unloading of the cargo material within the origin or destination locations 110, 120, 130, such as when loading or unloading equipment is malfunctioning or a large number of ground transportation units 102 are attempting to load or unload the cargo material. Accordingly, the stationary computing device 140 may automatically change the itinerary to reroute a ground transportation unit 102 from a location that is experiencing more delays to a location that is experiencing less delays.

Delays experienced by a ground transportation unit 102 at, in vicinity of, or otherwise in association with a location 110, 120, 130 may be determined by calculating the amount of time the ground transportation unit 102 spent within the location 110, 120, 130 to load and unload the cargo material, as well as the amount of time the ground transportation unit 102 spent entering and exiting the location 110, 120, 130. Thus, to calculate the amount of time the ground transportation unit 102 spent at or in association with a location 110, 120, 130, the amount of time the ground transportation unit 102 spent within staging areas 114, 124, 134 outside of the locations 110, 120, 130 may also be accounted for. The staging areas 114, 124, 134 may include driveways, ingresses/egresses, and portion of access roads leading into and out of the locations 110, 120, 130 where the ground transportation units 102 may wait or be delayed before entering and after exiting the locations 110, 120, 130. Geographic boundaries or zones 112, 122, 132 (e.g., geofences) may be defined to encompass areas associated with the locations 110, 120, 130 where transportation delays may be experienced. The zones 112, 122, 132 may encompass the entire locations 110, 120, 130, portions of the locations 110, 120, 130, and/or the staging areas 114, 124, 134 outside of the locations 110, 120, 130. The zones 112, 122, 132 may be virtually defined, for example, by establishing global positioning system (GPS) latitude and longitude coordinates coinciding with or encompassing the zones 112, 122, 132. The GPS coordinates may be coded or otherwise recorded on the stationary computing device 140 and/or the mobile computing devices 108, such that the mobile computing devices 108 can recognize or receive information indicative of entry into and exit out of the zones 112, 122, 132. Upon entry, the mobile computing devices 108 may generate and/or record shipping information indicative of entry of the mobile computing device 108 (and the ground transportation unit 102) into a zone 112, 122, 132 and, upon exit, the mobile computing devices 108 may generate and/or record shipping information indicative of exit of the mobile computing device 108 (and the ground transportation unit 102) out of a zone 112, 122, 132. The shipping information may include, for example, information or data indicative of time of entry into a location, time of exit from a location, name of the location, and GPS coordinates of the mobile computing device 108. Each mobile computing device 108 may also determine the amount of time spent by a corresponding ground transportation unit 102 within a zone 112, 122, 132. Additionally or alternatively, the stationary computing device 140 may determine the amount of time spent by a ground transportation unit 102 within a zone 112, 122, 132. Because the zone 112 is associated with the origin or loading location 110, the zone 112 may be referred to as a loading zone 112, and because the zones 122, 132 are associated with the destination or unloading locations 120, 130, the zones 122, 132 may be referred to as unloading zones 122, 132. However, if cargo is both loaded and unloaded in the zone 122, for example, zone 122 may be referred to both as a loading zone 122 and an unloading zone 122.

As described above, the shipping information generated and/or recorded by each mobile computing device 108 may be transmitted in real-time to the stationary computing device 140, where it may be received, recorded, and analyzed. Accordingly, the communication system 100 may be operable to determine travel delays associated with each location 110, 120, 130 and reroute certain ground transportation units 102 to different locations 110, 120, 130 than as originally planned. The communication system 100 may also or instead be operable to automatically determine demurrage costs resulting from shipping delays experienced in association with each location 110, 120, 130 (i.e., within each zone 112, 122, 132).

The demurrage costs incurred within each zone 112, 122, 132 may be determined based on time spent by the ground transportation units 102 within each zone that exceeds permitted time for which no demurrage costs are charged. For example, for each shipment of cargo material transported by the ground transportation units 102, the stationary computing device 140 may calculate a loading time spent within each loading zone 112 and an unloading time spent within each unloading zone 122, 132 based on a difference between the times at which each ground transportation unit 102 entered and exited each of the loading and unloading zones 112, 122, 132. The stationary computing device 140 may determine demurrage costs in real-time (running demurrage costs) while the shipment specified in the shipping itinerary is completed and record such demurrage costs. The stationary computing device 140 may change portions of the shipping itineraries for one or more of the ground transportation units 102 based on running demurrage costs for each zone 112, 122, 132 and/or based on historical demurrage costs (e.g., past week, month, year, same day each week, same week each month, same month each year, etc.) for each zone 112, 122, 132, such as to reduce demurrage costs for each zone 112, 122, 132.

The shipping and/or demurrage information recorded on the stationary computing device 140 may be accessible by multiple parties associated with the shipments of the cargo material. For example, the shipping and/or demurrage information may be accessed by a shipping (i.e., transportation) company that owns and/or operates the ground transportation units 102 and/or is hired to transport the cargo material from the origin location 110 to the destination locations 120, 130. Such access may permit the shipping company to receive and/or determine demurrage costs based on accurate shipping information and may permit invoices to be generated while the shipment specified in the shipping itinerary is completed. The shipping and/or demurrage information may be accessed by a hiring company that hired the shipping company to transport the cargo material. Such access may permit the hiring company to analyze the recorded shipping delays and check if the demurrage charges assessed by the shipping company are accurate. The hiring company may be a supply vendor that owns and/or operates the origin location 110 (e.g., material supply facility) and/or that is responsible for loading the cargo material onto the ground transportation units 102. The hiring company may be an operator and/or owner of the destination location 120, 130 (e.g., a well services company operating a wellsite) and/or that is responsible for unloading the cargo material from the ground transportation units 102. The owners and/or operators of the origin location 110 and the destination locations 120, 130 may be the same company.

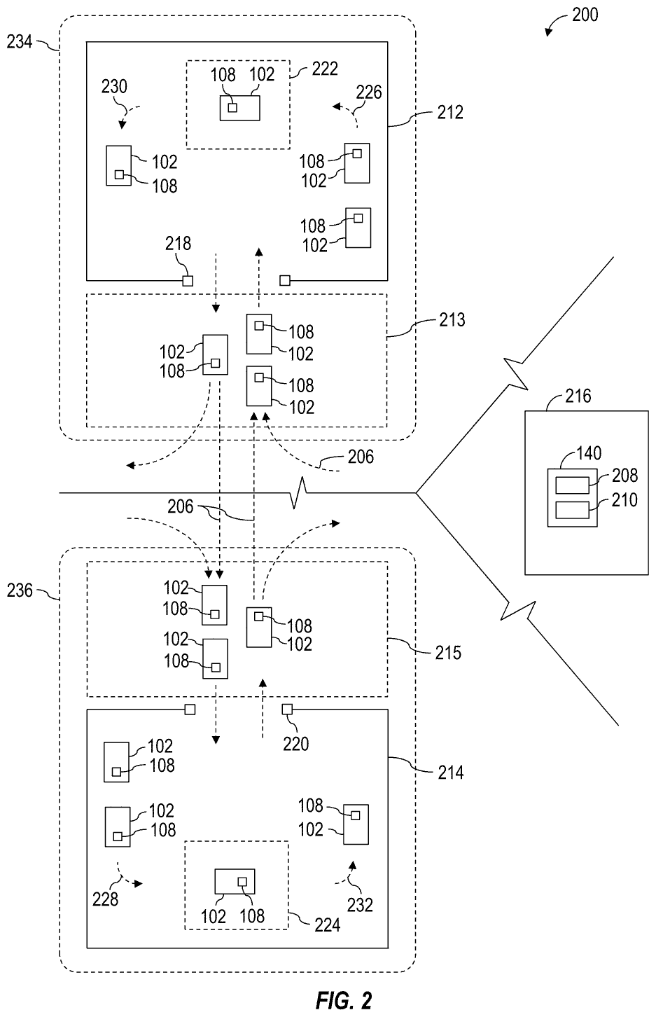

FIG. 2 is a schematic view of a portion of an example implementation of a communication system 200 utilized in the oil and gas (e.g., hydrocarbon extraction) industry according to one or more aspects of the present disclosure. The communication system 200 may comprise one or more features of the communication system 100 shown in FIG. 1, including where identified by the same numerals. The communication system 200 may be utilized in association with a material storage facility 212, a wellsite 214, and a data center 216, each of which may be geographically located at substantial distances from each other. It is noted that for the sake of clarity and ease of understanding FIG. 2 shows a single material storage facility 212 for storing materials (e.g., proppant, water, gelling agents, chemical additives, etc.) for use at the wellsite 214 and a single wellsite 214 having a well (not shown) for producing hydrocarbons, such as oil and/or gas. However, it is to be understood that aspects of the communication system 200 described below may be utilized in conjunction with a plurality of material storage facilities 212 and/or a plurality of wellsites 214.

The communication system 200 may comprise a plurality of mobile computing devices 108 each carried by or otherwise disposed in association with a corresponding ground transportation unit 102. For example, each mobile computing device 108 may be installed within the corresponding ground transportation unit 102, or each mobile computing device 108 may be carried by an operator (driver) of the corresponding ground transportation unit 102. Each mobile computing device 108 may be operable to generate, record, and/or transmit shipping information (including racking information) related to a corresponding shipment of cargo material involving the associated ground transportation unit 102. Each mobile computing device 108 may be or comprise a wireless transmitter and/or receiver (e.g., a transceiver) operable to wirelessly connect with a communication network, such as the wireless communication network 150 shown in FIG. 1.

The communication system 200 may further comprise a stationary computing device 140 (e.g., a server) housed within the data center 216. The mobile computing devices 108 may be communicatively connected with the stationary computing device 140, such as via the wireless communication network 150 and/or other communication networks. The stationary computing device 140 may comprise a processing device 208 and a memory 210 operable to store coded instructions that, when executed, may cause the processing device 208 to perform methods and actions described herein. The shipping information, including tracking information, generated and/or recorded by each mobile computing device 108, may be transmitted in real-time to the stationary computing device 140, to be received, processed, recorded, and/or analyzed. The stationary computing device 140 may, in turn, output a shipping itinerary and/or other information based on the received shipping information, e.g., for viewing by a user at the communication center 216 and/or for transmission to the mobile computing device(s) 108 for viewing by the driver(s).

FIG. 2 further shows example shipping routes 206 that may be taken by the ground transportation units 102 during a shipping (i.e., delivery) trip, as indicated by various arrows 206. The shipping routes 206 for each ground transportation unit 102 may be tracked, recorded, and analyzed in real-time by the stationary computing device 140. A shipping itinerary indicative of one or more shipments may be provided to each driver of a corresponding ground transportation unit 102. An example itinerary may indicate that a ground transportation unit 102 is to travel from a home base (not shown) to the material storage facility 212 to receive the cargo material and then travel to the wellsite 214 to unload at least a portion of the cargo material. The itinerary may further indicate that the ground transportation unit 102 is to then depart the wellsite 214 and return to the material storage facility 212 to pick up additional cargo material and then travel to the wellsite 214 or another wellsite (not shown) to unload the cargo material. The itinerary may further indicate that the ground transportation unit 102 is to then return to the home base.

However, while completing the itinerary, one or more of the ground transportation units 102 may experience delays at or near the material storage facility 212 and/or the wellsite 214. For example, the ground transportation units 102 may experience delays at or within one or more of staging areas 213, 215 outside of the material storage facility 212 and/or the wellsite 214. The staging areas 213, 215 may include driveways, ingresses, and portion of access roads leading into and out of the material storage facility 212 and the wellsite 214, where the ground transportation units 102 may wait or be delayed before entering and after exiting the material storage facility 212 and the wellsite 214 via corresponding gates 218, 220. The ground transportation units 102 may experience delays at or within the material storage facility 212 and the wellsite 214, such as before entering and after exiting loading and unloading areas 222, 224 within which the cargo material is loaded and unloaded, respectively. The loading and unloading areas 222, 224 may include, for example, areas adjacent to material transfer or handling units, material storage silos, material conveyor belts, material chutes, and other areas where the ground transportation units 102 may wait or be delayed before entering the loading and unloading areas 222, 224, as indicated by arrows 226, 228, before the cargo material is loaded and unloaded, and after exiting the loading and unloading areas 222, 224, as indicated by arrows 230, 232, after the cargo material is loaded and/or unloaded.

The stationary computing device 140 may be further operable to analyze movement and delays of the ground transportation units 102, e.g., between the material storage facility 212 and the wellsite 214, and change the itineraries of one or more of the ground transportations units 102, such as to reduce delays and demurrage costs associated with the storage facility 212 and the wellsite 214. Delays experienced by each ground transportation unit 102 at, in vicinity of, or otherwise in association with the material storage facility 212 and the wellsite 214 may be determined in part by calculating the amount of time each ground transportation unit 102 spent within the material storage facility 212 and the wellsite 214, as well as within the staging areas 213, 215 associated with the material storage facility 212 and the wellsite 214.

Geographic boundaries or zones 234, 236 (e.g., geofences) may be defined to encompass the material storage facility 212 and the wellsite 214, the loading and unloading areas 222, 224, and the staging areas 213, 215 outside of the material storage facility 212 and the wellsite 214. The zones 234, 236 may be virtually defined, for example, by establishing GPS latitude and longitude coordinates coinciding with or encompassing the zones 234, 236. The GPS coordinates may be coded or otherwise recorded on the stationary computing device 140 and/or the mobile computing devices 108, such that the mobile computing devices 108 and/or the stationary computing device 140 can recognize or receive information indicative of entry into and exit out of the zones 234, 236 by the mobile computing devices 108. Upon entry, the mobile computing devices 108 may generate and/or record shipping information indicative of entry of the mobile computing device 108 (and the ground transportation unit 102) into each zone 234, 236 and, upon exit, the mobile computing devices 108 may generate and/or record shipping information indicative of exit of the mobile computing device 108 (and the ground transportation unit 102) out of each zone 234, 236. The shipping information may include, for example, information or data indicative of time of entry into a zone 234, 236, time of exit from a zone 234, 236, name of the material storage facility 212 and the wellsite 214, and GPS coordinates of the mobile computing device 108 at a series of times. The stationary computing device 140 and/or each mobile computing device 108 may determine the amount of time spent by a corresponding ground transportation unit 102 within a zone 234, 236.

The mobile computing devices 108 may include optional means for manually confirming entry into and/or exit from each zone 234, 236. For example, the mobile computing device 108 may display a request (e.g., a software button, a checkbox, a dialog box, etc.) which, when manually indicated by the driver, confirms to the mobile computing device 108 that the corresponding ground transportation unit 102 has entered or exited one of the zones 234, 236. Manual confirmation of entry and/or exit from each zone 234, 236 may also or instead comprise displaying a bar code, a quick response (QR) code, and/or other pictorial (or alphanumeric) identifier, and scanning or otherwise causing such identifier to be read by an external reading device located in association with the gates 218, 220 or the staging areas 213, 215 to confirm to the mobile computing device 108 that the corresponding ground transportation unit 102 has entered or exited one of the zones 234, 236. Manual confirmation of entry into and/or exit from each zone 234, 236 may also or instead comprise scanning a radio-frequency identification (RFID) chip of a mobile computing device 108 by an external RFID reading device located in association with the gates 218, 220 or the staging areas 213, 215 to confirm to the mobile computing device 108 that the corresponding ground transportation unit 102 has entered or exited one of the zones 234, 236.

When the stationary computing device 140 determines that one or more of the ground transportation units 102 are experiencing or will experience delays at the material storage facility 212 and/or the wellsite 214, the stationary computing device 140 may then determine or propose in real-time changes to the predetermined itinerary (choose different shipping routes) for those ground transportation units 102 to reduce such delays, as well as demurrage costs that may be caused by or result from such delays. Changes to the itinerary may be automatically generated by the stationary computing device 140 or may be proposed, for confirmation by an authorized user of the stationary computing device 140, and then transmitted to the drivers in real-time via the mobile computing devices 108. The stationary computing device 140 may change (automatically or by proposal and confirmation) the shipping itineraries to reroute ground transportation units 102 from locations that experience more delays to locations that experience less delays. For example, after a ground transportation unit 102 exits the material storage facility 212, the revised itinerary may specify that the ground transportation unit 102 travel to another wellsite (not shown) instead of the wellsite 214 to unload the cargo material, for example, if the delays and/or associated demurrage costs can be reduced by traveling to the other wellsite. The revised itinerary may also or instead specify that a ground transportation unit 102 travelling from the wellsite 214 travel to another storage facility (not shown) instead of the storage facility 212 to receive the cargo material, for example, if delays and/or associated demurrage costs can be reduced by traveling to the other storage facility.

The shipping information generated and/or recorded by the mobile computing devices 108 and transmitted to the stationary computing device 140 may also or instead be utilized to automatically determine demurrage costs resulting from shipping delays experienced at the material storage facility 212 and/or the wellsite 214 (e.g., within each zone 234, 236). The demurrage costs incurred within each zone 234, 236 may be determined based on time spent by the ground transportation units 102 within each zone 234, 236 that exceeds permitted time for which no demurrage costs are charged. For example, for each shipment of cargo material transported by the ground transportation units 102, the stationary computing device 140 may calculate a loading time spent within the loading zone 234 and an unloading time spent within the unloading zone 236 based on a difference between the times at which each ground transportation unit 102 entered and exited each of the loading and unloading zones 234, 236. The stationary computing device 140 (and/or the mobile computing device 108) may determine the demurrage costs in real-time (running demurrage costs) while the shipping itineraries are completed. The stationary computing device 140 may change portions of shipping itineraries for one or more of the ground transportation units 102 based on running demurrage costs for each zone 234, 236 and/or based on historical (e.g., past week, month, year, same day each week, same week each month, same month each year, etc.) demurrage costs for each zone 234, 236, such as to reduce demurrage costs for each zone 234, 236.

The shipping and/or demurrage information generated by the stationary computing device 140 may be recorded and made accessible by one or more parties associated with the shipments of the cargo material between the material storage facility 212 and the wellsite 214. For example, the shipping and/or demurrage information may be accessed by a shipping (i.e., transportation) company that owns and/or operates the ground transportation units 102 and/or that is hired to transport the cargo material. The shipping and/or demurrage information may be accessed by a hiring company that hired the shipping company to transport the cargo material. The hiring company may be a supply vendor that owns and/or operates the material storage facility 212 and/or that is responsible for loading the cargo material onto the ground transportation units 102. The hiring company may be an operator and/or owner of the wellsite 214 (e.g., a well services company) and/or that is responsible for unloading the cargo material from the ground transportation units 102. The owners and/or operators of the material storage facility 212 and/or of the wellsite 214 may be the same party.

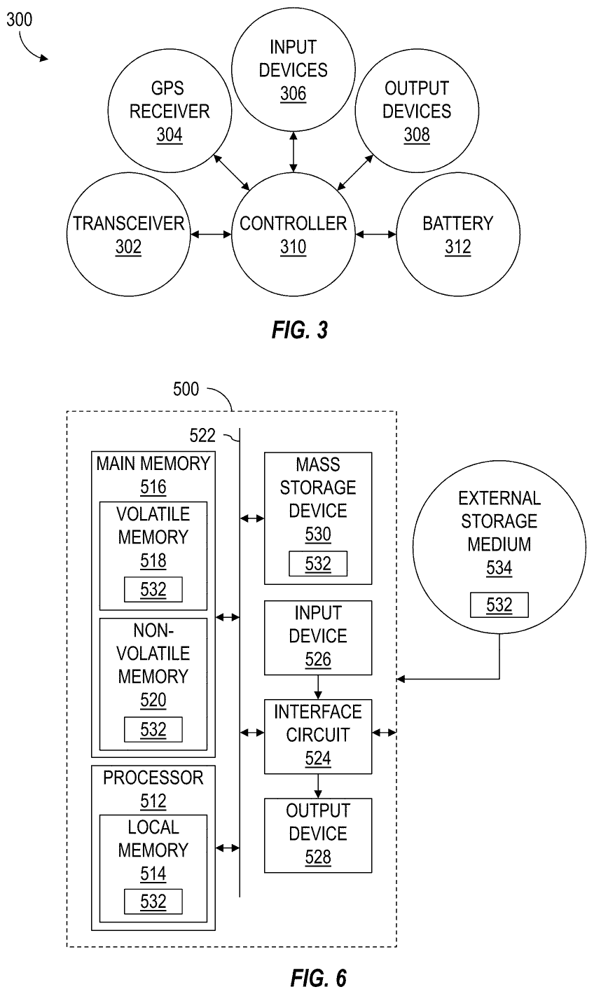

FIG. 3 is a schematic view of at least a portion of an example implementation of a mobile computing device 300 according to one or more aspects of the present disclosure. The mobile computing devices 108 shown in FIGS. 1 and 2 may comprise one or more features and/or modes of operation of the mobile computing device 300. The mobile computing device 300 may be carried by or otherwise disposed in association with a corresponding ground transportation unit 102. For example, the mobile computing device 300 may be installed within a ground transportation unit 102 or the mobile computing device 300 may be carried by an operator (driver) of the ground transportation unit 102. The following description refers to FIGS. 1-3, collectively.

The mobile computing device 300 may comprise a transceiver 302 operable to transmit and/or receive information via the wireless communication network 150, such as a mobile telecommunication cellular network or a satellite communication network. The transceiver 302 may be or comprise a very small aperture terminal (VSAT), a cellular network transceiver, a satellite transceiver, and/or another communication device operable to communicate via the wireless communication network 150. The mobile computing device 300 may comprise a GPS signal receiver 304 operable to receive or acquire location information from a GPS satellite, such as the communication satellite 154. The GPS signal receiver 304 or another feature of the mobile computing device 300 may utilize such location information to determine time-stamped geographical location of the mobile computing device 300 and, thus, an associated (e.g., co-located) ground transportation unit 102.

The mobile computing device 300 may further comprise one or more input devices 306, such as may permit the driver to enter data and/or commands to the mobile computing device 300. The input devices 306 may be, comprise, or be implemented by a keyboard, a mouse, a touchscreen, a track-pad, a trackball, an isopoint, and/or a voice recognition system, among other examples. The mobile computing device 300 may further comprise one or more output devices 308, such as may permit the driver to receive information from the mobile computing device 300. The output devices 308 may be, comprise, or be implemented by a video display device (e.g., a liquid crystal display (LCD) or cathode ray tube display (CRT)), a touchscreen, and/or speakers, among other examples. The mobile computing device 300 may also comprise a controller 310 in communication with the devices 302, 304, 306, 308. The controller 310 may comprise memory devices for storing computer programs, such as may include machine-readable coded instructions that, when executed, may cause the controller 310 to perform or to cause to be performed at least portions of methods and processes described herein. The mobile computing device 300 may be powered via connection with an electrical power circuit of the associated ground transportation unit 102. However, the mobile computing device 300 may also or instead comprise a local energy storage device, such as a battery 312, which may supply the mobile computing device 300 with electrical power. The mobile computing devices 108, 300 within the scope of the present disclosure may be or comprise a mobile cellular telephone.

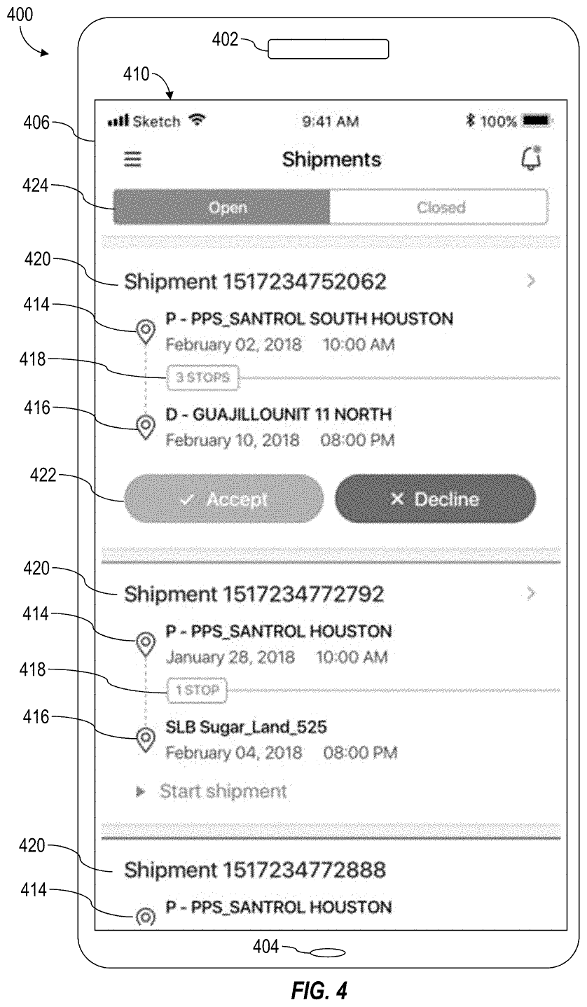

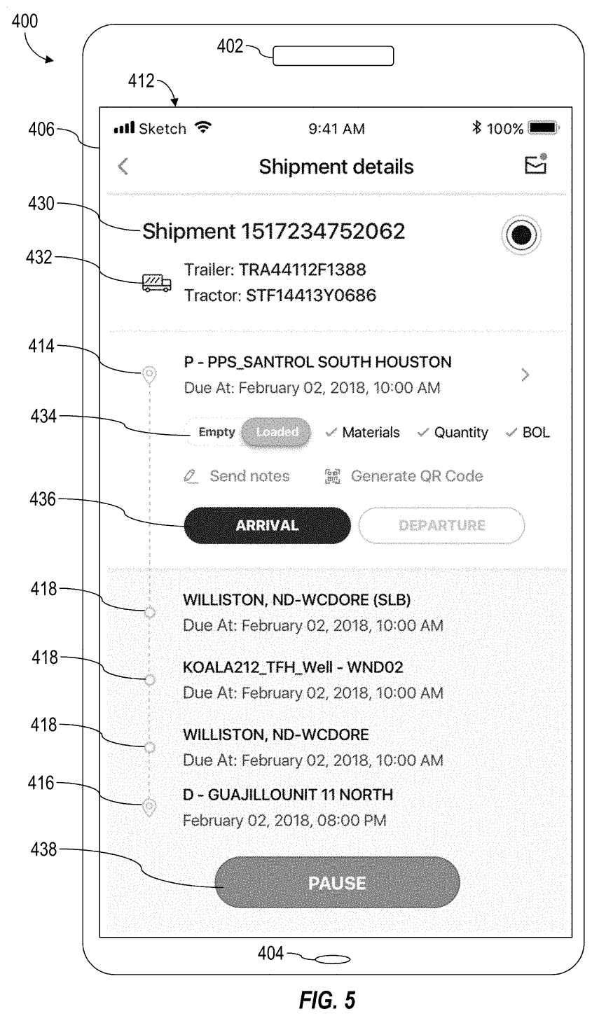

FIGS. 4 and 5 are views of an example implementation of a mobile computing device 400 implemented as a mobile cellular telephone, such as may be carried by an operator of a ground transportation unit 102, according to one or more aspects of the present disclosure. The mobile computing device 400 may comprise one or more features and/or modes of operation of the mobile computing devices 108, 300 shown in FIGS. 1-3. Accordingly, the following description refers to FIGS. 1-5, collectively.

The mobile computing device 400 may comprise a speaker 402, a microphone 404, and a video output screen 406 operable to generate or output various display screens associated with various non-transitory, computer-readable media (e.g., mobile cellular phone software applications) installed on and operable to be executed by the mobile computing device 400. Accordingly, the present disclosure is further directed to a non-transitory, computer-readable medium comprising coded instructions that, when executed by a processor of the mobile computing device 400, may cause the mobile computing device 400 to perform processes, operations, and/or methods described herein. The coded instructions may cause the mobile computing device 400 to generate and/or record shipping information, to transmit the shipping information, and to display on the video output screen 406 various display screens showing the shipping and other information that may be viewed and otherwise utilized by the operator (e.g., driver).

As shown in FIG. 4, the coded instructions may cause the mobile computing device 400 to receive one or more shipping itineraries and to generate/display on the video output screen 406 a display screen 410, e.g., entitled “Shipments,” comprising a listing of received shipping itineraries 420. For each shipping itinerary 420, the display screen 410 may list an origin location 414, a (final) destination location 416, and perhaps one or more intermediate destination locations 418 between the origin and (final) destination locations 414, 416. The display screen 410 may further list date and time of expected departure from the origin location 414 and/or expected arrival at the destination locations 416, 418. After the mobile computing device 400 receives an itinerary 420, the display screen 410 may further display a request to the driver to accept or decline the itinerary 420. The request may be or comprise software buttons 422, such as may be manually operated by the operator to accept or decline the associated itinerary 420. The display screen 410 may be opened and closed by manually operating software buttons 424 configured to open and close the display screen 410.

As shown in FIG. 5, the coded instructions may further cause the mobile computing device 400 to generate/display on the video output screen 406 a display screen 412, e.g., entitled “Shipment details,” comprising detailed information related to a selected itinerary 430. The display screen 412 may list identification information 432 of the trailer and/or tractor portions of the ground transportation unit 102. The display screen 412 may further list the origin location 414, the (final) destination location 416, and the intermediate destination locations 418. The display screen 412 may further list date and time of expected departure from the origin location 414 and/or expected arrival at the destination locations 416, 418. For each of the origin 414 and destination locations 416, 418, the display screen 412 may also permit the operator (driver) to manually confirm whether cargo material was loaded or unloaded, to input the cargo material being loaded or unloaded, to input the quantity of the cargo material being loaded or unloaded, and/or to generate/display a bill of lading, such as by manually operating a corresponding software button 434 and/or via a pop-up keyboard (not shown). In certain embodiments, the stationary computing device 140, and/or mobile computing devices 108, 300, 400, may use the input received through the software button 434 to change (automatically or by proposal and confirmation) the shipping itineraries to reroute ground transportation units 102 from the wellsite 214 to the nearest storage facility 212 instead of the originally planned storage facility, in order to reduce the associated costs and time traveled by ground transportation units that have been unloaded. The display screen 412 may additionally or alternatively display a request to the driver to manually confirm entry into (i.e., arrival at) and/or exit out of (i.e., departure from) the origin and/or destination locations 414, 416, 418, and/or the loading and/or unloading zones associated with the origin and/or destination locations 414, 416, 418. The request may be or comprise software buttons 436, such as may be manually operated by the driver to confirm such entry or exit. The tracking and/or other operations caused by the coded instructions of the mobile computing device 400 may be paused by manually operating a software button 438, such as when the driver is taking a break, is sleeping, is otherwise not driving the ground transportation unit 102, or, for some other reason (e.g., an emergency unrelated to the shipment), wishes to pause tracking and/or other operations of the ground transportation unit 102.

FIG. 6 is a schematic view of at least a portion of an example implementation of a processing device 500 according to one or more aspects of the present disclosure. The processing device 500 may be or form at least a portion of the mobile computing devices 108, 300, 400 shown in FIGS. 1-5 and/or the stationary computing device 140 shown in FIGS. 1 and 2. The processing device 500 may be in communication with, for example, the transceiver 302, the GPS receiver 304, the input devices 306, the output devices 308, and/or other devices of the mobile computing devices 108, 300, 400 and/or the stationary computing device 140. Accordingly, the following description refers to FIGS. 1-6, collectively.

The processing device 500 may be operable to receive a non-transitory, computer-readable medium comprising coded instructions 532 and shipping information, to process the coded instructions 532 and the shipping information, and to generate/display or record output information, e.g., to implement at least a portion of one or more example methods and operations described herein and/or to implement at least a portion of one or more of the example systems described herein.

The processing device 500 may be or comprise, for example, one or more processors, special-purpose computing devices, servers, personal computers (e.g., desktop, laptop, and/or tablet computers), personal digital assistant (PDA) devices, smartphones, internet appliances, and/or one or more other types of computing devices. The processing device 500 may comprise a processor 512, such as a general-purpose programmable processor. The processor 512 may comprise a local memory 514 and may execute the coded instructions 532 present in the local memory 514 and/or in another memory device. The processor 512 may execute, among other things, the machine-readable coded instructions 532 and/or other instructions and/or programs to implement the example methods and/or operations described herein. The programs stored in the local memory 514 may include program instructions or computer program code that, when executed by an associated processor, facilitate the mobile computing device 108, 300, 400 and/or the stationary computing device 140 to perform the example methods and/or operations described herein. The processor 512 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Of course, other processors from other families are also appropriate.

The processor 512 may be in communication with a main memory 516, such as may include a volatile memory 518 and a non-volatile memory 520, perhaps via a bus 522 and/or other communication means. The volatile memory 518 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 520 may be, comprise, or be implemented by read-only memory, flash memory, and/or other types of memory devices. One or more memory controllers (not shown) may control access to the volatile memory 518 and/or non-volatile memory 520.

The processing device 500 may also comprise an interface circuit 524. The interface circuit 524 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 524 may also comprise a graphics driver card. The interface circuit 524 may also comprise a communication device, such as a modem or network interface card to facilitate exchange of data with external computing devices via a network (e.g., Ethernet connection, digital subscriber line (DSL), telephone line, coaxial cable, cellular telephone system, satellite, etc.).

One or more input devices 526 may also be connected to the interface circuit 524. The input devices 526 may permit a ground transportation unit operator (driver) and/or other application/system users to enter portions of the coded instructions 532 and/or other data, such as control commands, processing routines, and input data. The input devices 526 may be, comprise, or be implemented by a keyboard, a mouse, a touchscreen, a track-pad, a trackball, an isopoint, and/or a voice recognition system, among other examples. One or more output devices 528 may also be connected to the interface circuit 524. The output devices 528 may be, comprise, or be implemented by display devices (e.g., a liquid crystal display (LCD), a light-emitting diode (LED) display, or cathode ray tube (CRT) display), printers, and/or speakers, among other examples. The processing device 500 may also communicate with one or more mass storage devices 530 and/or an external (e.g., removable) storage medium 534, such as may be or include floppy disk drives, hard drive disks, compact disk (CD) drives, digital versatile disk (DVD) drives, and/or USB and/or other flash drives, among other examples.

The coded instructions 532 may be stored in the mass storage device 530, the main memory 516, the local memory 514, and/or the removable storage medium 534. Thus, the processing device 500 may be implemented in accordance with hardware (perhaps implemented in one or more chips including an integrated circuit, such as an ASIC), or may be implemented as software or firmware for execution by the processor 512. In the case of firmware or software, the implementation may be provided as a computer program product including a non-transitory, computer-readable medium or storage structure embodying computer program code (i.e., software or firmware) thereon for execution by the processor 512. The coded instructions 532 may include program instructions or computer program code that, when executed by the processor 512, may cause the mobile computing devices 108, 300, 400 and/or the stationary computing device 140 to perform intended methods, processes, and/or operations disclosed herein.

For example, when the processing device 500 is or forms at least a portion of the stationary computing device 140, the coded instructions 532, when executed by the processor 512, may cause the stationary computing device 140 to receive and record shipping information for a plurality of shipments to be made and being made to and/or from a plurality of oil and gas wellsites 212, 214 using a plurality of ground transportation units 102, each shipment having an itinerary of one or more loading actions in one or more corresponding predetermined geographic loading zones 112, 234 and one or more unloading actions in one or more corresponding predetermined geographic unloading zones 122, 132, 236. As used herein, and as is known in the art, an “oil and gas wellsite” should be understood to mean any location or site from which an oil-based (petroleum) product is produced, from which a natural gas-based product is produced, or from which a combination thereof is produced. The shipping information for each shipment may comprise data indicating geographic location and time of each ground transportation unit 102 while each shipment is being performed, data indicating times at which each ground transportation unit 102 entered and exited each of the predetermined geographic loading zones 112, 234 during each shipment, and data indicating times at which each ground transportation unit 102 entered and exited each of the predetermined geographic unloading zones 122, 132, 236 during each shipment.

The coded instructions 532 may further comprise an algorithm for calculating demurrage costs for each shipment. The algorithm may comprise a loading demurrage time and an unloading demurrage time, at or below which no demurrage costs are invoiced. The coded instructions 532 may cause the stationary computing device 140 to, for each shipment, calculate a loading time spent within each of the predetermined geographic loading zones 112, 234 and an unloading time spent within each of the predetermined geographic unloading zones 122, 132, 236, based on a difference between the times at which each ground transportation unit 102 entered and exited each of the predetermined geographic loading and unloading zones 112, 122, 132, 234, 236, and, based on an analysis of the shipping information in real time, may suggest and/or implement changes to one or more future portions of a corresponding itinerary for one or more of the plurality of shipments to reduce loading time, unloading time, demurrage costs, or a combination thereof. In situations in which all times associated with a given itinerary are in the future, a “future portion” of the itinerary can include the entire itinerary or any portion thereof. The analysis of shipping information in real time may involve an assessment considering one or more factors, which may include, but are not necessarily limited to, (1) current or future predicted presence of at least a threshold number of ground transportation units within a given predetermined geographic loading or unloading zone; (2) current or future predicted increased demurrage costs related to a given predetermined geographic loading or unloading zone; (3) immediacy of a current or future predicted need of shipment cargo at a geographic loading or unloading zone; (4) current or future predicted improvement in cargo allocation across multiple geographic loading and/or unloading zones; (5) environmental conditions or constraints at a geographic loading or unloading zone or along a current itinerary route; or a combination thereof. An example of suggestions that can be made in response to assessment of factor (4) may include, e.g., those discussed in a commonly-assigned U.S. patent application Ser. No. 16/412,479, filed on May 15, 2019, and entitled “Operations Management Network System and Method,” the contents of which are incorporated by reference herein. The shipping information for each shipment may comprise boundaries of each predetermined geographic loading and unloading zone 112, 122, 132, 234, 236 for each shipment.

The coded instructions 532, when executed by the processor 512 of the stationary computing device 140, may cause the stationary computing device 140 to calculate demurrage costs for each shipment, based at least in part on the algorithm and on differences between each loading time and the loading demurrage time and between each unloading time and the unloading demurrage time. The demurrage costs can be determined, for example, by adjusting each loading time and unloading time by either a default demurrage time or a contractually-specified permitted demurrage time, which may be the same for loading and unloading operations. The difference between each loading/unloading time and each demurrage time may then be multiplied by a demurrage rate, which may be a default or contractually-specified value. However, if the demurrage cost calculation is based on two or more contractually-specified rates (e.g., a first demurrage rate for a first loading/unloading time over the default or contractually-specified demurrage time, a second demurrage rate for a second loading/unloading time over the first loading/unloading time, etc.), then such rates can be included in the algorithm for calculating the demurrage cost. For the demurrage cost calculation based on a simple rate (i.e., single rate) multiplication, the algorithm may include a contractually-specified demurrage time and a contractually-specified demurrage rate for calculating the demurrage cost. A plurality of shipping vendors (i.e., shipping companies) may be associated with the plurality of shipments, wherein each shipment may be associated with one of the plurality of shipping vendors, and wherein each shipping vendor may be provided access to the shipping information associated with its associated shipments, such that invoices for the associated shipments can be generated based on the shipping information.

The processing device 500 may also be or form at least a portion of each of the mobile computing devices 108, 300, 400, whereby the coded instructions 532, when executed by the processor 512, may cause each mobile computing device 108, 300, 400 to, via a GPS signal receiver 304 or other location acquisition means, receive and record data indicating geographic location of the mobile computing device 108, 300, 400, and thus of the co-located ground transportation unit 102. The coded instructions 532 may cause each mobile computing device 108, 300, 400 to record data indicating time for each of the data indicating geographic location of the mobile computing device 108, 300, 400, and thus of the co-located ground transportation unit 102, to receive and record data indicating geographic location of the predetermined geographic loading and unloading zones 112, 122, 132, 234, 236 for the shipment(s) corresponding to the co-located ground transportation unit 102, to record data indicating times at which each ground transportation unit 102 entered and exited each of the predetermined geographic loading zones 112, 234 during each shipment, and to record data indicating times at which each ground transportation unit 102 entered and exited each of the predetermined geographic unloading zones 122, 132, 236 during each shipment. The coded instructions 532 may cause each mobile computing device 108, 300, 400 to transmit, directly or indirectly, to the processor 512 of the stationary computing device 140 the data indicating geographic location and time of the mobile computing device 108, 300, 400, and, thus, of the co-located ground transportation unit 102, while each shipment is being performed, the data indicating times at which each ground transportation unit 102 entered and exited each of the predetermined geographic loading zones 112, 234 during each shipment, and the data indicating times at which each ground transportation unit 102 entered and exited each of the predetermined geographic unloading zones 122, 132, 236 during each shipment.

As mentioned above, the analysis of shipping information in real time may involve an assessment considering one or more factors, which may include but are not necessarily limited to, (1) current or future predicted presence of at least a threshold number of ground transportation units 102 within a given predetermined geographic loading or unloading zone 112, 122, 132, 234, 236; (2) current or future predicted increased demurrage costs related to a given predetermined geographic loading or unloading zone 112, 122, 132, 234, 236; (3) immediacy of a current or future predicted need of shipment cargo at a geographic loading or unloading zone 112, 122, 132, 234, 236; (4) current or future predicted improvement in cargo allocation across multiple geographic loading and/or unloading zones 112, 122, 132, 234, 236; (5) environmental conditions or constraints at a geographic loading or unloading zone 112, 122, 132, 234, 236 or along a current itinerary route; or a combination thereof. Based on the assessment of the one or more factors, the coded instructions 532 may cause the stationary computing device 140 to suggest and/or to implement changing a future portion of a corresponding itinerary for a corresponding ground transportation unit 102, optionally which has already accomplished a loading action of a shipment on the corresponding itinerary, to accomplish a future unloading action (i) at an alternate predetermined geographic unloading zone 132, 236 different from the predetermined geographic unloading zone 122, 236 on the itinerary for the corresponding ground transportation unit 102, (ii) at an alternate time from a time scheduled on the itinerary for the future unloading action at the predetermined geographic unloading zone 122, 236, or (iii) both (i) and (ii).

An itinerary may be selected for a ground transportation unit 102, optionally which has already accomplished a loading action of a shipment on the corresponding itinerary, a future portion of which itinerary contains at least two future unloading actions, at least one of which unloading actions is scheduled at a first predetermined geographic unloading zone 122, 236 and at least one of which unloading actions is scheduled at a second predetermined geographic unloading zone 132, 236. Based on the assessment of the one or more factors, the coded instructions 532 may cause the stationary computing device 140 to suggest and/or to implement changing a future portion of the itinerary to re-order future unloading actions, so that (i) a time scheduled for the unloading action at the first predetermined geographic location 122, 236 may be changed, (ii) a time scheduled for the unloading action at the second predetermined geographic location 132, 236 may be changed, or (iii) both (i) and (ii).

Furthermore, based on the assessment of the one or more factors, the coded instructions 532 may cause the stationary computing device 140 to suggest and/or to implement changing a future portion of a corresponding itinerary for a corresponding ground transportation unit 102 to accomplish a future loading action (i) at an alternate predetermined geographic loading zone 112, 234 different from the predetermined geographic loading zone 112, 234 on the itinerary for the corresponding ground transportation unit 102, (ii) at an alternate time from a time scheduled on the itinerary for the future loading action at the predetermined geographic loading zone 112, 234, or (iii) both (i) and (ii).

Based on the assessment of the one or more factors, the coded instructions 532 may cause the stationary computing device 140 to suggest and/or to implement changing a first shipping vendor associated with a ground transportation unit 102 scheduled to accomplish the corresponding shipment to a second shipping vendor associated with a second algorithm for calculating demurrage costs. The second algorithm may typically comprise a second loading demurrage time and a second unloading demurrage time, at or below which no demurrage costs are invoiced, and comprising a second demurrage rate. At least one of the following may be satisfied for a change to be suggested and/or implemented: the second demurrage rate may be lower than the first demurrage rate, the second loading demurrage time may be higher than the first loading demurrage time, and the second unloading demurrage time may be higher than the first unloading demurrage time.

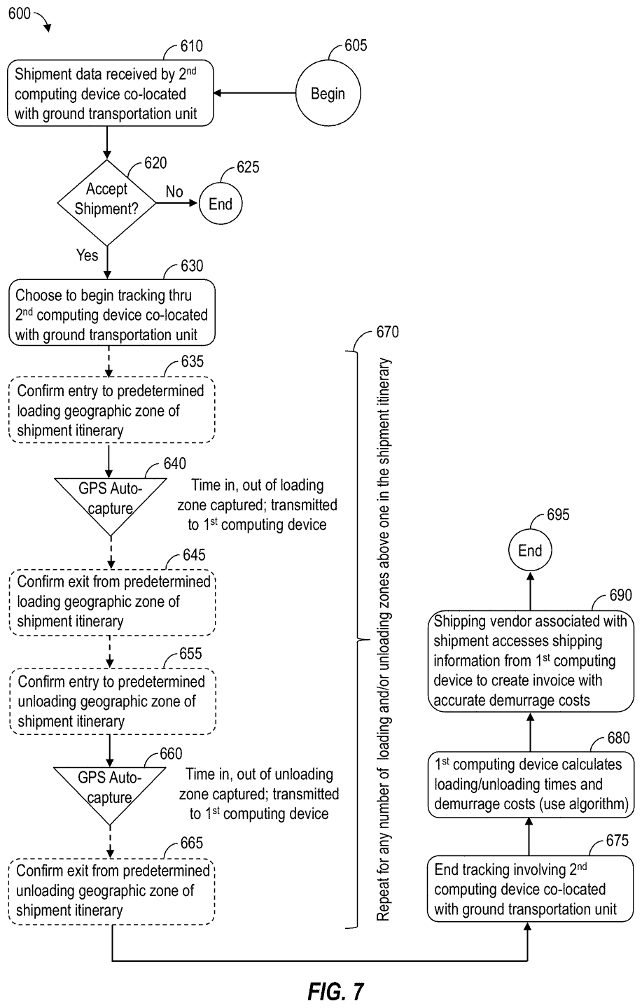

FIG. 7 is a flow-chart diagram of at least a portion of an example implementation of a method (600) according to one or more aspects of the present disclosure. The method (600) described below and/or other operations described herein may be performed utilizing or otherwise in conjunction with at least a portion of one or more implementations of one or more instances of the apparatus shown in one or more of FIGS. 1-6 and/or otherwise within the scope of the present disclosure. However, the method (600) and operations described herein may be performed in conjunction with implementations of apparatus other than those depicted in FIGS. 1-6 that are also within the scope of the present disclosure. The method (600) and operations may be performed or caused to be performed, at least partially, by the processing device 500 executing the coded instructions 532 according to one or more aspects of the present disclosure.

The method (600) may be utilized to accurately assess demurrage and/or to improve shipment efficiency related to demurrage. The portion of the method (600) begins at task (605). At a task (610), shipping information, such as transmitted by a first (e.g., stationary) computing device 140, including an itinerary for a shipment to and/or from an oil and gas wellsite 212, 214 may be received by a second (e.g., mobile) computing device 108 associated with a ground transportation unit 102 of a shipping vendor. The second computing device 108 may advantageously include or be a mobile computing device 300, such as a cellular telephone 400 and/or include or be a cellular network transceiver 302 and/or a satellite transceiver 302. The ground transportation unit 102 may advantageously include or be a truck/trailer 104, 106. In some implementations, the oil and gas wellsite 212, 214 may include or be a site where hydraulic fracturing is being accomplished and/or planned, and the shipment may contain proppant and/or at least a portion or ingredient of a fracturing fluid. At the task (620), an operator of the ground transportation unit 102 (e.g., a driver of the truck/trailer) with which the second computing device 108 is associated is prompted to accept or reject the shipment, based on the shipping information/itinerary provided. Although this portion of the method (600) prompts the operator of the ground transportation unit 102 of the shipping vendor for acceptance or rejection, it is contemplated that this acceptance or rejection can be additionally or alternatively delegated to or superseded by the shipping vendor or an agent thereof, in lieu of the operator. Rejection of the shipment at the prompt follows the “No” path to a task (625) indicating an end of the transaction. Acceptance of the shipment at the prompt follows the “Yes” path to a task (630).

Although the task (630) immediately follows the “Yes” path of the prompt choice at the task (620) in FIG. 7, it should be understood that the action of choosing to begin tracking the shipment via one or more transmissions from the second computing device 108 to the first computing device 140 may occur at some point, perhaps considerably later, such as when the ground transportation unit 102 is leaving a site owned or operated by the shipping vendor, is leaving an unloading zone 122, 132, 236 (e.g., a final unloading site) of a prior shipment, and/or has completed a prior shipment. As a result of the task (630), the second computing device 108 can automatically receive and record data indicating time-dependent geographic location of the second computing device 108 associated with (in this case, co-located with) the ground transportation unit 102, which, by virtue of the association (co-location), represents time-dependent geographic location of the ground transportation unit 102. This automatic receipt/acquisition of such data by the second computing device 108 may be facilitated by a GPS signal receiver 304, which may be or may be included with the second computing device 108. Data indicating geographic location from the GPS signal receiver can be matched with data indicating time, such that the second computing device 108 may receive and record data indicating its own (and thus its co-located ground transportation unit's) time-dependent geographic location.

At a time before or after the task (620) but before optional task (635) (e.g., at or immediately following the task (620) while following the “Yes” path to the task (630), or perhaps immediately before or after the task (630)), the second computing device 108 can receive (e.g., as transmitted from and/or accessed via the first computing device 140) and record data indicating geographic location of the predetermined geographic loading and unloading zones 112, 122, 132, 234, 236 for the shipment itinerary, the delivery of the shipment associated with which is itself associated with the ground transportation unit 102 co-located with the second computing device 108. By comparing the data indicating the time-dependent geographic location of the ground transportation unit 102 co-located with the second computing device 108 to the data indicating geographic location (boundaries) of the predetermined geographic loading and unloading zones for the shipment itinerary, at task (640), the second computing device 108 can automatically capture (i.e., record) data indicating an entry time at which the second computing device 108/ground transportation unit 102 enters a predetermined loading geographic zone 112, 234 and an exit time at which the second computing device 108/ground transportation unit 102 exits the predetermined loading geographic zone 112, 234. The second computing device 108 may transmit this data indicating the loading zone 112, 234 entry and exit times in real time, or there may be a delay, but the first computing device 140 can advantageously receive the data to facilitate effective tracking of the shipment.

Optionally, in tasks (635) and (645), respectively, entry into and/or exit out of the predetermined loading geographic zone 112, 234 of the shipment itinerary can be confirmed manually (as opposed to automatically), e.g., by the operator of the ground transportation unit 102 toggling a virtual switch (e.g., software button) on the second computing device 108 to indicate time of entry and/or exit. Other non-limiting examples of manual confirmation may include, but are not limited to, “badging in” and/or “badging out” of the predetermined loading geographic zone 112, 234, e.g., using an RFID detector and emitter, one of which may be embedded in the second computing device 108 or in the ground transportation unit co-located therewith and another of which may be placed at a location on a boundary of the predetermined loading geographic zone 112, 234 to interface with its corresponding portion on/in the second computing device 108/ground transportation unit 102; generating on the second computing device 108 a recognizable visual identifier for the shipment, such as a QR code, bar code, alphanumeric shipment identifier, and/or the like, reading the recognizable visual identifier with a scanning unit, and associating the recognizable visual identifier with the shipment, thereby capturing/recording time of entry and/or exit; or the like.

In some implementations, the optional manual confirmation of entry and/or exit in the tasks (635) and (645), respectively, may occur particularly when an automatically recorded entry and/or exit time (e.g., via GPS) involving the predetermined loading geographic zone 112, 234 does not reflect actual entry and/or exit therefrom. In some implementations, the optional manual confirmation of entry and/or exit in the tasks (635) and (645), respectively, may represent a simple confirmation of an already accurately recorded entry and/or exit time involving the predetermined loading geographic zone 112, 234. In addition, although FIG. 7 shows the optional task (635) as confirming entry before the task (640) of automatically capturing data indicating entry and/or exit time involving the predetermined loading geographic zone 112, 234, the optional task (635) may occur either before or after automatic capture of data indicating entry into the predetermined loading geographic zone 112, 234. Similarly, although FIG. 7 shows the optional task (645) as confirming exit after the task (640) of automatically capturing data indicating entry and/or exit time involving the predetermined loading geographic zone 112, 234, the optional task (645) may occur either before or after automatic capture of data indicating exit from the predetermined loading geographic zone 112, 234.

Upon exiting the predetermined loading geographic zone 112, 234, the ground transportation unit 102 then proceeds, based on the shipment itinerary, to a predetermined unloading geographic zone 122, 132, 236. By comparing the data indicating the time-dependent geographic location of the ground transportation unit 102 co-located with the second computing device 108 to the data indicating geographic location (boundaries) of the predetermined geographic loading and unloading zones 112, 122, 132, 234, 236 for the shipment itinerary, at task (660), the second computing device 108 can automatically capture (i.e., record) data indicating an entry time at which the second computing device 108/ground transportation unit 102 enters the predetermined unloading geographic zone 122, 132, 236 and an exit time at which the second computing device 108/ground transportation unit 102 exits the predetermined unloading geographic zone 122, 132, 236. The second computing device 108 may transmit this data indicating the times of entry into and exit from the predetermined unloading zone 122, 132, 236 in real time, or there may be a delay, but the first computing device 140 can advantageously receive the data to facilitate effective tracking of the shipment.

Optionally, in tasks (655) and (665), respectively, entry into and/or exit out of the predetermined unloading geographic zone 122, 132, 236 of the shipment itinerary can be confirmed manually (as opposed to automatically), e.g., by the operator of the ground transportation unit 102 toggling a virtual switch on the second computing device 108 to indicate time of entry and/or exit. As with loading, other non-limiting examples of manual unloading confirmation may include, but are not limited to, “badging in” and/or “badging out” of the predetermined unloading geographic zone 122, 132, 236, e.g., using an RFID detector and emitter, one of which may be embedded in the second computing device 108 or in the ground transportation unit 102 co-located therewith and another of which may be placed at a location on a boundary of the predetermined unloading geographic zone 122, 132, 236 to interface with its corresponding portion on/in the second computing device 108/ground transportation unit 102; generating on the second computing device 108 a recognizable visual identifier for the shipment, such as a QR code, bar code, alphanumeric shipment identifier, and/or the like, reading the recognizable visual identifier with a scanning unit, and associating the recognizable visual identifier with the shipment, thereby capturing/recording time of entry and/or exit; or the like.

In some implementations, the optional manual confirmation of entry and/or exit in the tasks (655) and (665), respectively, may occur particularly when an automatically recorded entry and/or exit time (e.g., via GPS) involving the predetermined unloading geographic zone 236 does not reflect actual entry and/or exit therefrom. In some implementations, the optional manual confirmation of entry and/or exit in the tasks (655) and (665), respectively, may represent a simple confirmation of an already accurately recorded entry and/or exit time involving the predetermined unloading geographic zone 122, 132, 236. In addition, although FIG. 7 shows the optional task (655) as confirming entry before the task (660) of automatically capturing data indicating entry and/or exit time involving the predetermined unloading geographic zone 122, 132, 236, the optional task (655) may occur either before or after automatic capture of data indicating entry into the predetermined unloading geographic zone 122, 132, 236. Similarly, although FIG. 7 shows the optional task (665) as confirming exit after the task (660) of automatically capturing data indicating entry and/or exit time involving the predetermined unloading geographic zone 122, 132, 236, the optional task (665) may occur either before or after automatic capture of data indicating exit from the predetermined unloading geographic zone 122, 132, 236.

As shown in task (670) of the portion of the method (600) in FIG. 7, when the shipment itinerary contains more than one predetermined loading and/or unloading geographic zone 112, 122, 132, 234, 236, the aspects of tasks (640) and/or (660), as well as optional tasks (635), (645), (655), and/or (665), may be repeated as many times as mandated to facilitate effective tracking of shipment throughout the itinerary. Although task (675) shows the action of choosing to end tracking the shipment, e.g., though use of the second computing device 108, as occurring separately from and after the capture and/or transmission of data indicating exit from the last predetermined loading and/or unloading zone on the shipment itinerary (whether task (660), optional task (665), or via repetition task (670)), it should be understood that ending the tracking of the shipment can occur at a convenient time, perhaps even simultaneously with and/or as a direct consequence of (automatic) task (660) and/or (manual) optional task (665).

Data captured and/or recorded by the second computing device 108 by virtue of actions taken between tasks (630) and (675) may be transmitted in a reasonable manner to the first computing device 140. Although it is specifically intended that such data may be transmitted in real time (as it is collected/captured) and/or with some slight delay, it is alternatively possible that such data may be transmitted at a point before or at task (675), or even immediately thereafter, so long as such data is transmitted to the first computing device 140 before task (680).

In task (680), the demurrage costs for the shipment can be calculated (e.g., by the first computing device 140) utilizing an algorithm for calculating demurrage costs and the data involving times of entry to and/or exit from each predetermined loading and unloading zone 112, 122, 132, 234, 236 in the shipment itinerary that was transmitted by the second computing device 108. The calculation may typically involve calculating a loading time spent within each of the predetermined geographic loading zones 112, 234 and an unloading time spent within each of the predetermined geographic unloading zones 122, 132, 236, which times may be based on a difference between the times at which each ground transportation unit 102 entered and exited each of the predetermined geographic loading and unloading zones 112, 122, 132, 234, 236. The loading and unloading times can then each be compared to a loading demurrage time and an unloading demurrage time from the algorithm, which represent times at or below which no demurrage costs are to be accrued/invoiced. In some circumstances, the algorithm may include a single enumerated demurrage time, in which case the loading demurrage time and the unloading demurrage time may be the same.

The demurrage calculation may generally involve calculating a loading/unloading elapsed time for each predetermined loading/unloading geographic zone 112, 122, 132, 234, 236 in the shipment itinerary, which elapsed time simply represents a difference between the exit time from the relevant predetermined geographic zone 112, 122, 132, 234, 236 and the entry time from the same relevant predetermined geographic zone 112, 122, 132, 234, 236. The demurrage calculation may generally also involve calculating a loading/unloading excess time for each predetermined loading/unloading geographic zone 112, 122, 132, 234, 236 in the shipment itinerary, which excess time simply represents a difference between the elapsed time from the relevant predetermined geographic zone 112, 122, 132, 234, 236 and the relevant demurrage time. If such difference is negative (i.e., if the relevant demurrage time is greater than the relevant elapsed time), then the loading/unloading excess time should be readjusted to zero. The demurrage calculation may involve a number of different algorithms, but generally involves at least some product involving a time value indicative of each loading/unloading excess time and a demurrage rate.

Typically, the loading and unloading demurrage times, as well as the manner by which demurrage is calculated (i.e., the algorithm for calculating demurrage), are specified in a contract or agreement between the shipping vendor and a requestor of shipping services (i.e., to whom a shipping invoice is to be sent, e.g., an organization, person, or group of people who interact(s) with the shipping vendor and/or on whose behalf the shipping vendor undertakes the shipment). The algorithm may be provided manually (e.g., by a user) or may be automatically extracted from terms of the contract/agreement and provided to the first computing device 140. If the demurrage time(s) is/are not specified in the contract/agreement and/or if there is no contract/agreement, the demurrage time(s) may represent a default value (e.g., one hour) or may be infinite (in which case no demurrage can accrue). If the demurrage calculation algorithm is not specified in the contract/agreement and/or if there is no contract/agreement, the demurrage calculation algorithm may represent a default algorithm. In some situations, the default algorithm may involve multiplying each loading/unloading excess time by a default demurrage rate (e.g., $60 per hour) and summing the products. In certain such situations, loading/unloading excess times having negative calculated values (where the relevant demurrage time is greater than the relevant elapsed time) may be retained as negative and not readjusted to zero, so that demurrage may be calculated on a total excess time basis (e.g., where “quick” loading or unloading at one or more of the predetermined geographic zones 112, 122, 132, 234, 236 on the shipment itinerary may be counted as a demurrage credit against a future or past incidence of “slow” loading or unloading at another one or more of the predetermined geographic zones 112, 122, 132, 234, 236). In some situations, the default algorithm may involve rounding each loading/unloading excess time to a set time increment (e.g., the next ¼ hour, the nearest ¼ hour, the next ½ hour, the nearest ½ hour, the next hour, or the nearest hour), counting how many set time increments that each excess time represents, summing a total number of set time increments for each excess time for each predetermined loading 112, 234/unloading geographic zone 122, 132, 236 listed on the shipment itinerary, and multiplying that total number of set time increments by a default demurrage rate specified per set time increment (e.g., $15 per ¼ hour, $30 per ½ hour, or $60 per hour).

At some point after demurrage costs are calculated, in task (690), the shipping vendor associated with the shipment (or an agent or delegee therefor) may access the shipping information, as well as the demurrage cost and the data collected in furtherance of calculating the demurrage cost, for the shipment from the first computing device 140, e.g., to create, modify, and/or upload an invoice associated with the shipment. Because the demurrage cost for each shipment is calculated using GPS technology, with an optional manual confirmation backup, it is believed that the demurrage cost calculation may be more accurate and reliable than other demurrage cost calculations, particularly when considered over hundreds or thousands or tens of thousands of shipments in a given time period (e.g., calendar year).

Although FIG. 7 describes a (portion of a) method (600) in which a first (stationary) computing device 140 shares shipment information regarding a single shipment with a shipping vendor and a second (mobile) computing device 108 co-located with the shipping vendor's ground transportation unit 102, it is expressly contemplated that methods of this disclosure may involve a plurality of second (mobile) computing devices 108, each associated (co-located) with a ground transportation unit 102 of a shipping vendor, sharing shipping information regarding a plurality of shipments with a first (stationary) computing device 140 (which may represent a single computing device or a networked array of computing devices). Furthermore, as described herein though not expressly shown in FIG. 7, the shipping information shared between the (each) second computing device 108 and the first computing device 140 can be analyzed, e.g., in real time, to facilitate suggestion of changes to one or more future portions of the (or another) corresponding shipment itinerary, with a particular goal or purpose, e.g., of reducing or minimizing loading time, reducing or minimizing unloading time, reducing or minimizing demurrage costs, reducing or minimizing shipment delays, or the like, or some combination thereof.

In view of the entirety of the present disclosure, including the figures and the claims, a person having ordinary skill in the art will readily recognize that the present disclosure introduces a computer program product comprising a non-transitory, computer-readable medium comprising instructions that, when executed by a processor of a computing device, cause the computing device to: (A) receive and record shipping information for a plurality of shipments to be made and being made to and/or from a plurality of oil and gas wellsites using a plurality of ground transportation units, each shipment having an itinerary of one or more loading actions in one or more corresponding predetermined geographic loading zones and one or more unloading actions in one or more corresponding predetermined geographic unloading zones, the shipping information for each shipment comprising: (i) data indicating geographic location and time of each ground transportation unit while each shipment is being performed; (ii) data indicating times at which each ground transportation unit entered and exited each of the predetermined geographic loading zones during each shipment; (iii) data indicating times at which each ground transportation unit entered and exited each of the predetermined geographic unloading zones during each shipment; and (iv) an algorithm for calculating demurrage costs for each shipment, the algorithm comprising a loading demurrage time and an unloading demurrage time at or below each of which no demurrage costs are invoiced; (B) for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones; and (C) based on an analysis of the shipping information in real time, suggest changes to one or more future portions of a corresponding itinerary for one or more of the plurality of shipments to reduce loading time, unloading time, demurrage costs, or a combination thereof.

The shipping information for each shipment may further comprise boundaries of each predetermined geographic loading and unloading zone for each shipment.

The instructions, when executed by the processor, may further cause the computing device to calculate demurrage costs for each shipment, based at least in part on the algorithm and on differences between each loading time and the loading demurrage time and between each unloading time and the unloading demurrage time. A plurality of shipping vendors may be associated with the plurality of shipments, each shipment may be associated with one of the plurality of shipping vendors, and each shipping vendor may be provided access to the shipping information associated with its associated shipments so that invoices for the associated shipments can be generated based on the shipping information.

The non-transitory, computer-readable medium may be a first non-transitory, computer-readable medium, the instructions may be first instructions, the processor may be a first processor, the computing device may be a first computing device, and the computer program product may further comprise a plurality of second non-transitory, computer-readable media, each comprising second instructions that, when executed by a second processor of a second computing device co-located with each ground transportation unit, may cause each second computing device to: (A) via a GPS signal receiver, receive and record data indicating geographic location of the second computing device, and thus of the co-located ground transportation unit; (B) record data indicating time for each of the data indicating geographic location of the second computing device, and thus of the co-located ground transportation unit; (C) receive and record data indicating geographic location of the predetermined geographic loading and unloading zones for the shipment(s) corresponding to the co-located ground transportation unit; (D) record data indicating times at which each ground transportation unit entered and exited each of the predetermined geographic loading zones during each shipment; (E) record data indicating times at which each ground transportation unit entered and exited each of the predetermined geographic unloading zones during each shipment; and (F) transmit, directly or indirectly, to the first processor: (i) the data indicating geographic location and time of the second computing device, and thus of the co-located ground transportation unit, while each shipment is being performed; (ii) the data indicating times at which each ground transportation unit entered and exited each of the predetermined geographic loading zones during each shipment; and (iii) the data indicating times at which each ground transportation unit entered and exited each of the predetermined geographic unloading zones during each shipment. Each second computing device may be or comprise a cellular network transceiver and/or a satellite transceiver. Each second computing device may be or comprise a mobile cellular telephone.

The analysis of shipping information in real time may comprise assessment of one or more factors comprising: current or future predicted presence of at least a threshold number of ground transportation units within a given predetermined geographic loading or unloading zone; current or future predicted increased demurrage costs related to a given predetermined geographic loading or unloading zone; immediacy of a current or future predicted need of shipment cargo at a geographic loading or unloading zone; current or future predicted improvement in cargo allocation across multiple geographic loading and/or unloading zones; environmental conditions or constraints at a geographic loading or unloading zone or along a current itinerary route; or a combination thereof. The instructions may, based on the assessment of the one or more factors, cause the computing device to suggest changing a future portion of a corresponding itinerary for a corresponding ground transportation unit to accomplish a future unloading action (i) at an alternate predetermined geographic unloading zone different from the predetermined geographic unloading zone on the itinerary for the corresponding ground transportation unit, (ii) at an alternate time from a time scheduled on the itinerary for the future unloading action at the predetermined geographic unloading zone, or (iii) both (i) and (ii). The corresponding ground transportation unit may have already accomplished a loading action of a shipment on the corresponding itinerary. An itinerary may be selected for a ground transportation unit, a future portion of which itinerary may contain at least two future unloading actions, at least one of which unloading actions may be scheduled at a first predetermined geographic unloading zone and at least one of which unloading actions may be scheduled at a second predetermined geographic unloading zone, and the instructions may, based on the assessment of the one or more factors, cause the computing device to suggest changing a future portion of the itinerary to re-order future unloading actions, so that (i) a time scheduled for the unloading action at the first predetermined geographic location may be changed, (ii) a time scheduled for the unloading action at the second predetermined geographic location may be changed, or (iii) both (i) and (ii). The corresponding ground transportation unit may have already accomplished a loading action of a shipment on the corresponding itinerary.

The instructions may, based on the assessment of the one or more factors, cause the computing device to suggest changing a future portion of a corresponding itinerary for a corresponding ground transportation unit to accomplish a future loading action (i) at an alternate predetermined geographic loading zone different from the predetermined geographic loading zone on the itinerary for the corresponding ground transportation unit, (ii) at an alternate time from a time scheduled on the itinerary for the future loading action at the predetermined geographic loading zone, or (iii) both (i) and (ii).

The algorithm may be a first algorithm associated with a first shipping vendor, the first algorithm may further comprise a first demurrage rate, the loading demurrage time may be a first loading demurrage time, the unloading demurrage time may be a first unloading demurrage time, the first shipping vendor may be associated with a first ground transportation unit currently scheduled to accomplish a corresponding itinerary, and the instructions may, based on the assessment of the one or more factors, cause the computing device to suggest changing the first shipping vendor associated with a ground transportation unit scheduled to accomplish the corresponding shipment to a second shipping vendor. The second shipping vendor may be associated with a second algorithm for calculating demurrage costs. The second algorithm may comprise a second loading demurrage time and a second unloading demurrage time, at or below which no demurrage costs are invoiced, and comprising a second demurrage rate. At least one of the following may be satisfied for a change to be suggested: the second demurrage rate is lower than the first demurrage rate; the second loading demurrage time is higher than the first loading demurrage time; and the second unloading demurrage time is higher than the second unloading demurrage time.

The present disclosure also introduces a system comprising: a computing device comprising a processor; and a non-transitory, computer-readable medium comprising instructions. The instructions, when executed by the processor of the computing device, cause the computing device to: (A) receive and record shipping information for a plurality of shipments to be made and being made to and/or from a plurality of oil and gas wellsites using a plurality of ground transportation units, each shipment having an itinerary of one or more loading actions in one or more corresponding predetermined geographic loading zones and one or more unloading actions in one or more corresponding predetermined geographic unloading zones, the shipping information for each shipment comprising: (i) data indicating geographic location and time of each ground transportation unit while each shipment is being performed; (ii) data indicating times at which each ground transportation unit entered and exited each of the predetermined geographic loading zones during each shipment; (iii) data indicating times at which each ground transportation unit entered and exited each of the predetermined geographic unloading zones during each shipment; and (iv) an algorithm for calculating demurrage costs for each shipment, the algorithm comprising a loading demurrage time and an unloading demurrage time, at or below each of which no demurrage costs are invoiced; (B) for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones; and (C) based on an analysis of the shipping information in real time, suggest changes to one or more future portions of a corresponding itinerary for one or more of the plurality of shipments to reduce loading time, unloading time, demurrage costs, or a combination thereof.

The shipping information for each shipment may further comprise boundaries of each predetermined geographic loading and unloading zone for each shipment.

The instructions, when executed by the processor of the computing device, may further cause the computing device to calculate demurrage costs for each shipment, based at least in part on the algorithm and on differences between each loading time and the loading demurrage time and between each unloading time and the unloading demurrage time. A plurality of shipping vendors may be associated with the plurality of shipments. Each shipment may be associated with one of the shipping vendors. Each shipping vendor may be provided access to the shipping information associated with its associated shipments so that invoices for the associated shipments can be generated based on the shipping information.

The non-transitory, computer-readable medium may be a first non-transitory, computer-readable medium, the instructions may be first instructions, the processor may be a first processor, the computing device may be a first computing device, and the system may further comprise a plurality of second non-transitory, computer-readable media, each comprising second instructions that, when executed by a second processor of a second computing device co-located with each ground transportation unit, may cause each second computing device to: (A) via a GPS signal receiver, receive and record data indicating geographic location of the second computing device, and thus of the co-located ground transportation unit; (B) record data indicating time for each of the data indicating geographic location of the second computing device, and thus of the co-located ground transportation unit; (C) receive and record data indicating geographic location of the predetermined geographic loading and unloading zones for the shipment(s) corresponding to the co-located ground transportation unit; (D) record data indicating times at which each ground transportation unit entered and exited each of the predetermined geographic loading zones during each shipment; (E) record data indicating times at which each ground transportation unit entered and exited each of the predetermined geographic unloading zones during each shipment; and (F) transmit, directly or indirectly, to the first processor of the first computing device: (i) the data indicating geographic location and time of the second computing device, and thus of the co-located ground transportation unit, while each shipment is being performed; (ii) the data indicating times at which each ground transportation unit entered and exited each of the predetermined geographic loading zones during each shipment; and (iii) the data indicating times at which each ground transportation unit entered and exited each of the predetermined geographic unloading zones during each shipment. Each second computing device may be or comprise a cellular network transceiver and/or a satellite transceiver. Each second computing device may be or comprise a mobile cellular telephone.

The analysis of shipping information in real time may comprise assessment of one or more factors comprising: current or future predicted presence of at least a threshold number of ground transportation units within a given predetermined geographic loading or unloading zone; current or future predicted increased demurrage costs related to a given predetermined geographic loading or unloading zone; immediacy of a current or future predicted need of shipment cargo at a geographic loading or unloading zone; current or future predicted improvement in cargo allocation across multiple geographic loading and/or unloading zones; environmental conditions or constraints at a geographic loading or unloading zone or along a current itinerary route; or a combination thereof. Based on the assessment of the one or more factors, the instructions may cause the computing device to suggest changing a future portion of a corresponding itinerary for a corresponding ground transportation unit to accomplish a future unloading action (i) at an alternate predetermined geographic unloading zone different from the predetermined geographic unloading zone on the itinerary for the corresponding ground transportation unit, (ii) at an alternate time from a time scheduled on the itinerary for the future unloading action at the predetermined geographic unloading zone, or (iii) both (i) and (ii). The corresponding ground transportation unit may have already accomplished a loading action of a shipment on the corresponding itinerary.

An itinerary may be selected for a ground transportation unit, a future portion of which itinerary may contain at least two future unloading actions, at least one of which unloading actions may be scheduled at a first predetermined geographic unloading zone and at least one of which unloading actions may be scheduled at a second predetermined geographic unloading zone. Based on the assessment of the one or more factors, the instructions may cause the computing device to suggest changing a future portion of the itinerary to re-order future unloading actions, so that (i) a time scheduled for the unloading action at the first predetermined geographic location is changed, (ii) a time scheduled for the unloading action at the second predetermined geographic location is changed, or (iii) both (i) and (ii). The corresponding ground transportation unit may have already accomplished a loading action of a shipment on the corresponding itinerary.

Based on the assessment of the one or more factors, the instructions may cause the computing device to suggest changing a future portion of a corresponding itinerary for a corresponding ground transportation unit to accomplish a future loading action (i) at an alternate predetermined geographic loading zone different from the predetermined geographic loading zone on the itinerary for the corresponding ground transportation unit, (ii) at an alternate time from a time scheduled on the itinerary for the future loading action at the predetermined geographic loading zone, or (iii) both (i) and (ii).

The algorithm may be a first algorithm associated with a first shipping vendor, and the first algorithm may further comprise a first demurrage rate. The loading demurrage time may be a first loading demurrage time, and the unloading demurrage time may be a first unloading demurrage time. The first shipping vendor may be associated with a first ground transportation unit currently scheduled to accomplish a corresponding itinerary. Based on the assessment of the one or more factors, the instructions may cause the computing device to suggest changing the first shipping vendor associated with a ground transportation unit scheduled to accomplish the corresponding shipment to a second shipping vendor, which second shipping vendor may be associated with a second algorithm for calculating demurrage costs. The second algorithm may comprise a second loading demurrage time and a second unloading demurrage time, at or below which no demurrage costs are invoiced, and comprising a second demurrage rate. At least one of the following may be satisfied for a change to be suggested: the second demurrage rate is lower than the first demurrage rate; the second loading demurrage time is higher than the first loading demurrage time; and the second unloading demurrage time is higher than the second unloading demurrage time.

The present disclosure also introduces a method for monitoring and/or controlling demurrage costs, the method comprising causing a computing device to: (A) receive and record shipping information for a plurality of shipments to be made and being made to and/or from a plurality of oil and gas wellsites using a plurality of ground transportation units, each shipment having an itinerary of one or more loading actions in one or more corresponding predetermined geographic loading zones and one or more unloading actions in one or more corresponding predetermined geographic unloading zones, the shipping information for each shipment comprising: (i) data indicating geographic location and time of each ground transportation unit as each shipment is being performed; (ii) data indicating times at which each ground transportation unit entered and exited each of the predetermined geographic loading zones during each shipment; (iii) data indicating times at which each ground transportation unit entered and exited each of the predetermined geographic unloading zones during each shipment; and (iv) an algorithm for calculating demurrage costs for each shipment, the algorithm comprising a loading demurrage time and an unloading demurrage time, at or below each of which no demurrage costs are invoiced; (B) for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones; and (C) based on an analysis of the shipping information in real time, suggest changes to one or more future portions of a corresponding itinerary for one or more of the plurality of shipments to reduce loading time, unloading time, demurrage costs, or a combination thereof. The computing device comprises a processor comprising a non-transitory, computer-readable medium that comprises instructions that are executed by the processor of the computing device, resulting in at least a portion of the method being undertaken.

The shipping information for each shipment may further comprise boundaries of each predetermined geographic loading and unloading zone for each shipment.

The method may further comprise causing the computing device to calculate demurrage costs for each shipment, based at least in part on the algorithm and on differences between each loading time and the loading demurrage time and between each unloading time and the unloading demurrage time. A plurality of shipping vendors may be associated with the plurality of shipments. Each shipment may be associated with one of the shipping vendors. Each shipping vendor may be provided access to the shipping information associated with its associated shipments so that invoices for the associated shipments can be generated based on the shipping information.

The non-transitory, computer-readable medium may be a first non-transitory, computer-readable medium, the instructions may be first instructions, the processor may be a first processor, the computing device may be a first computing device, and a computer program product comprising the first non-transitory, computer-readable medium may further comprise a plurality of second non-transitory, computer-readable media, each comprising second instructions executable by a processor of a second computing device. The method may further comprise causing each of the plurality of second computing devices, each associated with a corresponding co-located ground transportation unit, to: (A) via a GPS signal receiver, receive and record data indicating geographic location of the second computing device, and thus of the co-located ground transportation unit; (B) record data indicating time for each of the data indicating geographic location of the second computing device, and thus of the co-located ground transportation unit; (C) receive and record data indicating geographic location of the predetermined geographic loading and unloading zones for the shipment(s) corresponding to the co-located ground transportation unit; (D) record data indicating times at which each ground transportation unit entered and exited each of the predetermined geographic loading zones during each shipment; (E) record data indicating times at which each ground transportation unit entered and exited each of the predetermined geographic unloading zones during each shipment; and (F) transmit, directly or indirectly, to the first processor of the first computing device: (i) the data indicating geographic location and time of the second computing device, and thus of the co-located ground transportation unit, as each shipment is being performed; (ii) the data indicating times at which each ground transportation unit entered and exited each of the predetermined geographic loading zones during each shipment; and (iii) the data indicating times at which each ground transportation unit entered and exited each of the predetermined geographic unloading zones during each shipment. Each second computing device may be or comprise a cellular network transceiver and/or a satellite transceiver. Each second computing device may be or comprise a mobile cellular telephone.

The analysis of shipping information in real time may comprise assessment of one or more factors comprising: current or future predicted presence of at least a threshold number of ground transportation units within a given predetermined geographic loading or unloading zone; current or future predicted increased demurrage costs related to a given predetermined geographic loading or unloading zone; immediacy of a current or future predicted need of shipment cargo at a geographic loading or unloading zone; current or future predicted improvement in cargo allocation across multiple geographic loading and/or unloading zones; environmental conditions or constraints at a geographic loading or unloading zone or along a current itinerary route; or a combination thereof. The method may further comprise causing the computing device, based on the assessment of the one or more factors, to suggest changing a future portion of a corresponding itinerary for a corresponding ground transportation unit to accomplish a future unloading action (i) at an alternate predetermined geographic unloading zone different from the predetermined geographic unloading zone on the itinerary for the corresponding ground transportation unit, (ii) at an alternate time from a time scheduled on the itinerary for the future unloading action at the predetermined geographic unloading zone, or (iii) both (i) and (ii). The corresponding ground transportation unit may have already accomplished a loading action of a shipment on the corresponding itinerary.

An itinerary may be selected for a ground transportation unit, a future portion of which itinerary may contain at least two future unloading actions, at least one of which unloading actions may be scheduled at a first predetermined geographic unloading zone and at least one of which unloading actions may be scheduled at a second predetermined geographic unloading zone. The method may further comprise causing the computing device, based on the assessment of the one or more factors, to cause the computing device to suggest changing a future portion of the itinerary to re-order future unloading actions, so that (i) a time scheduled for the unloading action at the first predetermined geographic location is changed, (ii) a time scheduled for the unloading action at the second predetermined geographic location is changed, or (iii) both (i) and (ii). The corresponding ground transportation unit may have already accomplished a loading action of a shipment on the corresponding itinerary.

The method may further comprise causing the computing device, based on the assessment of the one or more factors, to suggest changing a future portion of a corresponding itinerary for a corresponding ground transportation unit to accomplish a future loading action (i) at an alternate predetermined geographic loading zone different from the predetermined geographic loading zone on the itinerary for the corresponding ground transportation unit, (ii) at an alternate time from a time scheduled on the itinerary for the future loading action at the predetermined geographic loading zone, or (iii) both (i) and (ii).

The algorithm may be a first algorithm associated with a first shipping vendor, and the first algorithm may further comprise a first demurrage rate. The loading demurrage time may be a first loading demurrage time, and the unloading demurrage time may be a first unloading demurrage time. The first shipping vendor may be associated with a first ground transportation unit currently scheduled to accomplish a corresponding itinerary. The method may further comprise causing the computing device, based on the assessment of the one or more factors, to suggest changing the first shipping vendor associated with a ground transportation unit scheduled to accomplish the corresponding shipment to a second shipping vendor, which second shipping vendor may be associated with a second algorithm for calculating demurrage costs. The second algorithm may comprise a second loading demurrage time and a second unloading demurrage time, at or below which no demurrage costs are invoiced, and comprising a second demurrage rate. At least one of the following may be satisfied for a change to be suggested: the second demurrage rate is lower than the first demurrage rate; the second loading demurrage time is higher than the first loading demurrage time; and the second unloading demurrage time is higher than the second unloading demurrage time.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to permit the reader to quickly ascertain the nature of the technical disclosure. It is submitted with the understanding that it will not be used to interpret or limit the scope or meaning of the claims.

What is claimed is:

1. A computer program product comprising:
a non-transitory, computer-readable medium comprising instructions that, when executed by a processor of a computing device, cause the computing device to:
receive and record shipping information for a plurality of shipments to be made and being made to and/or from a plurality of oil and gas wellsites using a plurality of ground transportation units, each shipment having an itinerary of one or more loading actions in one or more corresponding predetermined geographic loading zones and one or more unloading actions in one or more corresponding predetermined geographic unloading zones, the shipping information for each shipment comprising:
data indicating geographic location and time of each ground transportation unit while each shipment is being performed;
data indicating times at which each ground transportation unit entered and exited each of the predetermined geographic loading zones during each shipment;
data indicating times at which each ground transportation unit entered and exited each of the predetermined geographic unloading zones during each shipment; and
an algorithm for calculating demurrage costs for each shipment, the algorithm comprising a loading demurrage time and an unloading demurrage time at or below each of which no demurrage costs are invoiced;
for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones; and
based on an analysis of the shipping information in real time, suggest changes to one or more future portions of a corresponding itinerary for one or more of the plurality of shipments to reduce loading time, unloading time, demurrage costs, or a combination thereof.

2. The computer program product of claim 1 wherein the instructions, when executed by the processor, further cause the computing device to calculate demurrage costs for each shipment, based at least in part on the algorithm and on differences between each loading time and the loading demurrage time and between each unloading time and the unloading demurrage time.

3. The computer program product of claim 2 wherein a plurality of shipping vendors are associated with the plurality of shipments, each shipment being associated with one of the plurality of shipping vendors, and wherein each shipping vendor is provided access to the shipping information associated with its associated shipments so that invoices for the associated shipments can be generated based on the shipping information.

4. The computer program product of claim 1 wherein:
the non-transitory, computer-readable medium is a first non-transitory, computer-readable medium, the instructions are first instructions, the processor is a first processor, and the computing device is a first computing device; and
the computer program product further comprises a plurality of second non-transitory, computer-readable media, each comprising second instructions that, when executed by a second processor of a second computing device co-located with each ground transportation unit, cause each second computing device to:
receive and record data indicating geographic location of the second computing device, and thus of the co-located ground transportation unit;
record data indicating time for each of the data indicating geographic location of the second computing device, and thus of the co-located ground transportation unit;
receive and record data indicating geographic location of the predetermined geographic loading and unloading zones for the shipment(s) corresponding to the co-located ground transportation unit;
record data indicating times at which each ground transportation unit entered and exited each of the predetermined geographic loading zones during each shipment;
record data indicating times at which each ground transportation unit entered and exited each of the predetermined geographic unloading zones during each shipment; and
transmit, directly or indirectly, to the first processor:
the data indicating geographic location and time of the second computing device, and thus of the co-located ground transportation unit, while each shipment is being performed;
the data indicating times at which each ground transportation unit entered and exited each of the predetermined geographic loading zones during each shipment; and
the data indicating times at which each ground transportation unit entered and exited each of the predetermined geographic unloading zones during each shipment.

5. The computer program product of claim 1, wherein the analysis of shipping information in real time comprises assessment of one or more factors comprising: current or future predicted presence of at least a threshold number of ground transportation units within a given predetermined geographic loading or unloading zone; current or future predicted increased demurrage costs related to a given predetermined geographic loading or unloading zone; immediacy of a current or future predicted need of shipment cargo at a geographic loading or unloading zone; current or future predicted improvement in cargo allocation across multiple geographic loading and/or unloading zones; environmental conditions or constraints at a geographic loading or unloading zone or along a current itinerary route; or a combination thereof.

6. The computer program product of claim 5 wherein:
the algorithm is a first algorithm associated with a first shipping vendor, the first algorithm further comprising a first demurrage rate;
the loading demurrage time is a first loading demurrage time, and the unloading demurrage time is a first unloading demurrage time;
the first shipping vendor is associated with a first ground transportation unit currently scheduled to accomplish a corresponding itinerary; and
based on the assessment of the one or more factors, the instructions cause the computing device to suggest changing the first shipping vendor associated with a ground transportation unit scheduled to accomplish the corresponding shipment to a second shipping vendor, which second shipping vendor is associated with a second algorithm for calculating demurrage costs, the second algorithm comprising a second loading demurrage time and a second unloading demurrage time at or below which no demurrage costs are invoiced, and comprising a second demurrage rate at least one of the following being satisfied for a change to be suggested:
the second demurrage rate is lower than the first demurrage rate;
the second loading demurrage time is higher than the first loading demurrage time; and
the second unloading demurrage time is higher than the second unloading demurrage time.

7. A system comprising:
a computing device comprising a processor; and
a non-transitory, computer-readable medium comprising instructions that, when executed by the processor of the computing device, cause the computing device to:
receive and record shipping information for a plurality of shipments to be made and being made to and/or from a plurality of oil and gas wellsites using a plurality of ground transportation units, each shipment having an itinerary of one or more loading actions in one or more corresponding predetermined geographic loading zones and one or more unloading actions in one or more corresponding predetermined geographic unloading zones, the shipping information for each shipment comprising:
data indicating geographic location and time of each ground transportation unit while each shipment is being performed;
data indicating times at which each ground transportation unit entered and exited each of the predetermined geographic loading zones during each shipment;
data indicating times at which each ground transportation unit entered and exited each of the predetermined geographic unloading zones during each shipment; and
an algorithm for calculating demurrage costs for each shipment, the algorithm comprising a loading demurrage time and an unloading demurrage time, at or below each of which no demurrage costs are invoiced;
for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones; and
based on an analysis of the shipping information in real time, suggest changes to one or more future portions of a corresponding itinerary for one or more of the plurality of shipments to reduce loading time, unloading time, demurrage costs, or a combination thereof.

8. The system of claim 7 wherein the shipping information for each shipment further comprises boundaries of each predetermined geographic loading and unloading zone for each shipment.

9. The system of claim 7 wherein the instructions, when executed by the processor of the computing device, further cause the computing device to calculate demurrage costs for each shipment, based at least in part on the algorithm and on differences between each loading time and the loading demurrage time and between each unloading time and the unloading demurrage time.

10. The system of claim 9 wherein a plurality of shipping vendors are associated with the plurality of shipments, each shipment being associated with one of the plurality of shipping vendors, and wherein each shipping vendor is provided access to the shipping information associated with its associated shipments so that invoices for the associated shipments can be generated based on the shipping information.

11. The system of claim 7 wherein:
the non-transitory, computer-readable medium is a first non-transitory, computer-readable medium, the instructions are first instructions, the processor is a first processor, and the computing device is a first computing device; and
the system further comprises a plurality of second non-transitory, computer-readable media, each comprising second instructions that, when executed by a second processor of a second computing device co-located with each ground transportation unit, cause each second computing device to:
receive and record data indicating geographic location of the second computing device, and thus of the co-located ground transportation unit;
record data indicating time for each of the data indicating geographic location of the second computing device, and thus of the co-located ground transportation unit;
receive and record data indicating geographic location of the predetermined geographic loading and unloading zones for the shipment(s) corresponding to the co-located ground transportation unit;
record data indicating times at which each ground transportation unit entered and exited each of the predetermined geographic loading zones during each shipment;
record data indicating times at which each ground transportation unit entered and exited each of the predetermined geographic unloading zones during each shipment; and
transmit, directly or indirectly, to the first processor of the first computing device:
the data indicating geographic location and time of the second computing device, and thus of the co-located ground transportation unit, while each shipment is being performed;
the data indicating times at which each ground transportation unit entered and exited each of the predetermined geographic loading zones during each shipment; and
the data indicating times at which each ground transportation unit entered and exited each of the predetermined geographic unloading zones during each shipment.

12. A method for monitoring and/or controlling demurrage costs, the method comprising causing a computing device to:
receive and record shipping information for a plurality of shipments to be made and being made to and/or from a plurality of oil and gas wellsites using a plurality of ground transportation units, each shipment having an itinerary of one or more loading actions in one or more corresponding predetermined geographic loading zones and one or more unloading actions in one or more corresponding predetermined geographic unloading zones, the shipping information for each shipment comprising:
data indicating geographic location and time of each ground transportation unit as each shipment is being performed;
data indicating times at which each ground transportation unit entered and exited each of the predetermined geographic loading zones during each shipment;
data indicating times at which each ground transportation unit entered and exited each of the predetermined geographic unloading zones during each shipment; and
an algorithm for calculating demurrage costs for each shipment, the algorithm comprising a loading demurrage time and an unloading demurrage time, at or below each of which no demurrage costs are invoiced;
for each shipment, calculate a loading time spent within each of the predetermined geographic loading zones and an unloading time spent within each of the predetermined geographic unloading zones, based on a difference between the times at which each ground transportation unit entered and exited each of the predetermined geographic loading and unloading zones; and
based on an analysis of the shipping information in real time, suggest changes to one or more future portions of a corresponding itinerary for one or more of the plurality of shipments to reduce loading time, unloading time, demurrage costs, or a combination thereof,
wherein the computing device comprises a processor comprising a non-transitory, computer-readable medium that comprises instructions that are executed by the processor of the computing device, resulting in at least a portion of the method being undertaken.

13. The method of claim 12 further comprising causing the computing device to calculate demurrage costs for each shipment, based at least in part on the algorithm and on differences between each loading time and the loading demurrage time and between each unloading time and the unloading demurrage time.

14. The method of claim 13 wherein a plurality of shipping vendors are associated with the plurality of shipments, each shipment being associated with one of the plurality of shipping vendors, and wherein each shipping vendor is provided access to the shipping information associated with its associated shipments so that invoices for the associated shipments can be generated based on the shipping information.

15. The method of claim 12 wherein:
the non-transitory, computer-readable medium is a first non-transitory, computer-readable medium, the instructions are first instructions, the processor is a first processor, and the computing device is a first computing device;
a computer program product comprising the first non-transitory, computer-readable medium further comprises a plurality of second non-transitory, computer-readable media, each comprising second instructions executable by a processor of a second computing device; and
the method further comprises causing each of the plurality of second computing devices, each associated with a corresponding co-located ground transportation unit to:
receive and record data indicating geographic location of the second computing device, and thus of the co-located ground transportation unit;
record data indicating time for each of the data indicating geographic location of the second computing device, and thus of the co-located ground transportation unit;
receive and record data indicating geographic location of the predetermined geographic loading and unloading zones for the shipment(s) corresponding to the co-located ground transportation unit;
record data indicating times at which each ground transportation unit entered and exited each of the predetermined geographic loading zones during each shipment;
record data indicating times at which each ground transportation unit entered and exited each of the predetermined geographic unloading zones during each shipment; and
transmit, directly or indirectly, to the first processor of the first computing device:
the data indicating geographic location and time of the second computing device, and thus of the co-located ground transportation unit, as each shipment is being performed;
the data indicating times at which each ground transportation unit entered and exited each of the predetermined geographic loading zones during each shipment; and
the data indicating times at which each ground transportation unit entered and exited each of the predetermined geographic unloading zones during each shipment.

16. The method of claim 12, wherein the analysis of shipping information in real time comprises assessment of one or more factors comprising: current or future predicted presence of at least a threshold number of ground transportation units within a given predetermined geographic loading or unloading zone; current or future predicted increased demurrage costs related to a given predetermined geographic loading or unloading zone; immediacy of a current or future predicted need of shipment cargo at a geographic loading or unloading zone; current or future predicted improvement in cargo allocation across multiple geographic loading and/or unloading zones; environmental conditions or constraints at a geographic loading or unloading zone or along a current itinerary route; or a combination thereof.

17. The method of claim 16 further comprising causing the computing device, based on the assessment of the one or more factors, to suggest changing a future portion of a corresponding itinerary for a corresponding ground transportation unit to accomplish a future unloading action (i) at an alternate predetermined geographic unloading zone different from the predetermined geographic unloading zone on the itinerary for the corresponding ground transportation unit, (ii) at an alternate time from a time scheduled on the itinerary for the future unloading action at the predetermined geographic unloading zone, or (iii) both (i) and (ii).

18. The method of claim 16 wherein:
an itinerary is selected for a ground transportation unit, a future portion of which itinerary contains at least two future unloading actions, at least one of which unloading actions is scheduled at a first predetermined geographic unloading zone and at least one of which unloading actions is scheduled at a second predetermined geographic unloading zone; and
the method further comprises causing the computing device, based on the assessment of the one or more factors, the instructions cause the computing device to suggest changing a future portion of the itinerary to re-order future unloading actions, so that (i) a time scheduled for the unloading action at the first predetermined geographic location is changed, (ii) a time scheduled for the unloading action at the second predetermined geographic location is changed, or (iii) both (i) and (ii).

19. The method of claim 16 further comprising causing the computing device, based on the assessment of the one or more factors, to suggest changing a future portion of a corresponding itinerary for a corresponding ground transportation unit to accomplish a future loading action (i) at an alternate predetermined geographic loading zone different from the predetermined geographic loading zone on the itinerary for the corresponding ground transportation unit, (ii) at an alternate time from a time scheduled on the itinerary for the future loading action at the predetermined geographic loading zone, or (iii) both (i) and (ii).

20. The method of claim 16 wherein:
the algorithm is a first algorithm associated with a first shipping vendor, the first algorithm further comprising a first demurrage rate;
the loading demurrage time is a first loading demurrage time, and the unloading demurrage time is a first unloading demurrage time;
the first shipping vendor is associated with a first ground transportation unit currently scheduled to accomplish a corresponding itinerary; and
the method further comprises causing the computing device, based on the assessment of the one or more factors, to suggest changing the first shipping vendor associated with a ground transportation unit scheduled to accomplish the corresponding shipment to a second shipping vendor, which second shipping vendor is associated with a second algorithm for calculating demurrage costs, the second algorithm comprising a second loading demurrage time and a second unloading demurrage time, at or below which no demurrage costs are invoiced, and comprising a second demurrage rate, at least one of the following being satisfied for a change to be suggested:
the second demurrage rate is lower than the first demurrage rate;
the second loading demurrage time is higher than the first loading demurrage time; and
the second unloading demurrage time is higher than the second unloading demurrage time.
